(19) United States
(12) Patent Application Publication
(10) Pub. No.: US 2014/0134535 A1
(43) Pub. Date: May 15, 2014

(54) MAGNETIC CARRIER AND TWO-COMPONENT DEVELOPER

(71) Applicant: CANON KABUSHIKI KAISHA, Tokyo (JP)

(72) Inventors: Yoshinobu Baba, Yokohama-shi (JP); Koh Ishigami, Abiko-shi (JP); Masayuki Hama, Toride-shi (JP); Kentaro Kamae, Kashiwa-shi (JP); Hiroaki Kawakami, Yokohama-shi (JP)

(73) Assignee: CANON KABUSHIKI KAISHA, Tokyo (JP)

(21) Appl. No.: 14/158,183

(22) Filed: Jan. 17, 2014

Related U.S. Application Data
(63) Continuation of application No. PCT/JP2013/004727, filed on Aug. 5, 2013.

(30) Foreign Application Priority Data
Aug. 8, 2012 (JP) 2012-175723

(51) Int. Cl. G03G 9/107

(52) U.S. Cl. CPC G03G 9/1075
USPC 430/111.35

(57) ABSTRACT

Provided is a magnetic carrier satisfying leakage, white spots, charging property and high developing performance in a low electric field and having excellent durability. The magnetic carrier is a magnetic carrier comprising a magnetic substance-dispersed resin carrier core containing a magnetic substance and a binder resin, and a coating resin on a surface thereof, wherein the magnetic substance comprises a magnetic substance A having a shape without vertexes and a magnetic substance B having a shape with vertexes, the magnetic substance B has a number average particle diameter of 0.40-2.00 μm, and in a reflection electron image of a section of the magnetic substance-dispersed resin carrier core taken by a scanning electron microscope, an area proportion of the magnetic substance B is larger than an area proportion of the magnetic substance A within a region from the surface of the magnetic substance-dispersed resin carrier core to a depth of 1.0 μm.

### CROSS-REFERENCE TO RELATED APPLICATIONS

This application is a continuation of International Application No. PCT/JP2013/004727, filed Aug. 5, 2013, which claims the benefit of Japanese Patent Application No. 2012-175723, filed Aug. 8, 2012.

### BACKGROUND OF THE INVENTION

1. Field of the Invention

The present invention relates to a magnetic carrier to be used in an image forming method for developing an electrostatic charge image by use of electrophotography and a two-component developer using the magnetic carrier.

2. Description of the Related Art

In a conventional electrophotographic-system image forming method generally employed, an electrostatic latent image is formed on an electrostatic latent image bearing member by use of various processes and toner is adhered on the electrostatic latent image to develop the image. In developing the image, a carrier particle called a magnetic carrier is mixed with toner to triboelectrically charge the toner. In this manner, an appropriate amount of positive or negative charge is imparted to the toner. The toner is developed by using the charge as driving force. This is a two-component development system, which has been widely used.

In the two-component development system, since a magnetic carrier can play a part in stirring, transporting and charging of a developer, the function of the magnetic carrier is clearly distinguished from that of a toner. This is advantageous since the performance of the developer can be easily controlled.

However, with technological evolution of the electrophotographic field, it has recently been more and more strenuously demanded to not only reduce the space and volume of a main body of an apparatus but also increase the operation speed and extension of life of the apparatus, as well as high definition and stable quality of image.

In the circumstances, an attempt has been made to reduce the size and the number of parts of a main-body apparatus and save energy power. Also in development, it is demanded to reduce the size of a transformer. If the strength of a development electric field is increased, a flying amount of toner and uniformity of a solid image and a half-tone image can be improved; however, adhesion and leakage of a carrier tend to occur, causing image defects. Because of this, in order to stably develop an image even in a low electric field, an attempt has been made to improve the developing performance of a magnetic carrier.

Furthermore, it is required for a developer to provide stable developing performance for a long time. To obtain long-term stability, an attempt has been made to reduce specific gravity and magnetic force of a magnetic carrier. Employing ferrite using a light element, porous ferrite and a magnetic substance-dispersed resin carrier has been proposed.

A magnetic carrier prepared by filling and coating a porous magnetic ferrite core with a resin and defining the strength of an electric field right before breakdown of the magnetic carrier is proposed (International Application No. WO2010/016605). According to the magnetic carrier proposed, improvement of developing performance at a low electric field strength and further improvement in stabilization of long term developing performance can be attained. However, when an image having a large image-area is printed out in a large quantity under a high temperature and high humidity environment, the coating layer of the magnetic carrier is partially worn. As a result, an electric field converges on the portion of the coating resin layer reduced in thickness, causing leakage, as the case may be.

Furthermore, as a magnetic substance-dispersed resin carrier, a magnetic substance-dispersed resin carrier having a high electric resistance and a low magnetic force is proposed in which magnetite and hematite are used in combination to increase resistivity of the core (Japanese Patent Application Laid-Open No. H08-160671). However, since the carrier as mentioned above is further reduced in specific gravity and magnetic force, higher quality and definition images can be obtained and durability is improved; however, developing performance decreases in some cases. The developing performance decreases because carrier resistance increases and thereby an electrode effect decreases. As a result, toner is scraped off from the rear end of a half tone portion at the border between a half tone image portion and a solid image portion to form a white streak. In this manner, an image defect, which emphasizes the edge of the solid image portion, (hereinafter referred to as a white spot) often occurs.

To deal with the image defects, i.e., to improve migration of carrier particles and suppress white spots, an idea of using two types of magnetite particles different in size and controlling the layer structure formed of two types of magnetite particles has been proposed (Japanese Patent Application Laid-Open No. 2007-322892). According to this technique, large magnetite particles are allowed to be present in the surface of the core to impart irregularity to the surface, thereby improving migration; and that the conductivity of the surface layer portion of the carrier is relatively increased than that of the interior portion of the carrier to accelerate relaxation of counter charge, thereby suppressing formation of white spots. However, since the shape of magnetite particles used here is spherical, the surface of the coating layer tends to be smooth and toner spent often occurs if use is made for a long time. Furthermore, when development is performed at a low electric field strength, if the resistivity of a core is decreased, white spots often appear on a solid image. The white spots are produced when charge leakage occurs from a development sleeve to a photosensitive member through a carrier. Then, if the core resistance is set such that no leakage occurs, developing performance at a low electric field strength often decreases. Likewise, the balance between the developing performance and leakage cannot be maintained in some cases.

A magnetic carrier preventing toner spent and peel-off and wear of a coating layer, attaining long-term stability is proposed (Japanese Patent Application Laid-Open No. 2011-13676). This is an idea that the shapes of magnetite particles different in size are variously changed to control irregularity due to the shape of large magnetite particles, thereby improving the adhesion property of a coating layer to reduce peel-off and wear and improve durability. However, since the magnetite used here is low in resistance, if a magnetic carrier is produced by a routine manner, core resistance becomes too low to prevent leakage. Then, a surface treatment is applied to magnetite particles to increase the resistance of the core. As described, if the resistance of the core increases, developing performance at a low electric field strength cannot be enhanced.

Accordingly, it has been strongly desired to develop a magnetic carrier causing no leakage, having excellent developing performance at a low electric field strength and being used stably during long-term repeated use.

### SUMMARY OF THE INVENTION

The present invention is directed to providing a magnetic carrier and two-component developer overcoming the aforementioned problems.

More specifically, the present invention is directed to providing a magnetic carrier and a two-component developer capable of suppressing white spots caused by leakage and capable of providing a satisfactory image excellent in developing performance at a low electric field strength and having high image quality without white spots, stably during long-term repeated use.

Furthermore, the present invention is directed to providing a magnetic carrier and a two-component developer excellent in preventing spent and providing less change in charge quantity, thereby capable of stably providing a good image having less change in developing performance during long-term repeated use.

According to one aspect of the present invention, there is provided a magnetic carrier comprising a magnetic substance-dispersed resin carrier core, which contains a magnetic substance and a binder resin, and a coating resin on a surface thereof, in which

the magnetic substance comprises a magnetic substance A having a shape without vertexes and a magnetic substance B having a shape with vertexes,

the magnetic substance B has a number average particle diameter of 0.40 μm or more and 2.00 μm or less, and

in a reflection electron image of a section of the magnetic substance-dispersed resin carrier core taken by a scanning electron microscope, an area proportion of the magnetic substance B is larger than an area proportion of the magnetic substance A within a region from the surface of the magnetic substance-dispersed resin carrier core to a depth of 1.0 μm.

According to another aspect of the present invention, there is provided a two-component developer comprising a toner and the above-described magnetic carrier.

Use of the magnetic carrier of the present invention enables to provide a magnetic carrier satisfying leakage, white spots, charging property and high developing performance in a low electric field and having excellent durability.

Further features of the present invention will become apparent from the following description of exemplary embodiments with reference to the attached drawings.

### BRIEF DESCRIPTION OF THE DRAWINGS

FIG. 1 is a photograph showing a projection image which is a visualized sectional reflection electron image of a magnetic substance-dispersed resin carrier core (core 1) of the present invention (2000×).

FIG. 2 is a photograph showing an enlarged projection image of the portion near the surface of the carrier core shown in FIG. 1 (10000×).

FIG. 3 is a schematic view of the magnetic substance-dispersed resin carrier core of FIG. 2, in which the area from the surface to a depth of 1.0 μm is defined.

FIG. 4 is a photograph showing a projection image which is visualized sectional reflection electron image of the portion near the surface of a magnetic substance-dispersed resin carrier core (core 19) according to a Comparative Example (10000×).

FIG. 5A is a schematic view of an apparatus for measuring the resistivity of a magnetic substance, magnetic substance-dispersed resin carrier core and magnetic carrier used in the present invention.

FIG. 5B is a schematic view of an apparatus for measuring the resistivity of a magnetic substance, magnetic substance-dispersed resin carrier core and magnetic carrier used in the present invention.

### DESCRIPTION OF THE EMBODIMENTS

Preferred embodiments of the present invention will now be described in detail in accordance with the accompanying drawings.

The magnetic carrier of the present invention is a magnetic carrier comprising a magnetic substance-dispersed resin carrier core, which contains a magnetic substance and a binder resin, and a coating resin on a surface thereof, in which

the magnetic substance comprises a magnetic substance A having a shape without vertexes and a magnetic substance B having a shape with vertexes,

the magnetic substance B has a number average particle diameter of 0.40 μm or more and 2.00 μm or less, and

in a reflection electron image of a section of the magnetic substance-dispersed resin carrier core taken by a scanning electron microscope, an area proportion of the magnetic substance B is larger than an area proportion of the magnetic substance A within a region from the surface of the magnetic substance-dispersed resin carrier core to a depth of 1.0 μm. Note that “magnetic substance-dispersed resin carrier core” will be hereinafter simply referred to as the “carrier core”.

As described above, the present invention relates to a carrier including the two types of magnetic substances, i.e., the magnetic substance A having a shape without vertexes and the magnetic substance B having a shape with vertexes as the magnetic substance to be used in the carrier core, which are each controlled in size and state of presence in the carrier core. By virtue of such a structure, occurrence of leakage is suppressed and excellent developing performance can be obtained.

The difference between a magnetic substance having a shape without vertexes and a magnetic substance having a shape with vertexes will be described. In a sectional image of a magnetic-substance particle observed by SEM, the magnetic substance having a shape without vertexes refers to particles having a shape without vertexes of an angle of 150° or less, in other words, virtually spherical particles. The magnetic substance having a shape with vertexes refers to particles having vertexes of an angle 150° or less. FIG. 2 shows a reflection electron image of a section of a portion near a carrier core surface, obtained by an FIB treatment. In FIG. 2, most of magnetic substances present in the portion near a particle surface correspond to the magnetic substances having vertexes; whereas, most of the magnetic substances present in the interior portion correspond to the magnetic substances having a shape without vertexes.

Examples of the magnetic substance having a shape with vertexes include tetrahedral, pentahedral, hexahedral, heptahedral and octahedral magnetic substances and a mixture of these as well as irregular magnetic substances having edges different in length. Examples of the magnetic substance having no vertexes include a polyhedral (icosahedron or more) magnetic substance and a spherical magnetic substance.

Magnetic substance B includes particles having a number average particle diameter of 0.40 μm or more and 2.00 μm or less and a shape having vertexes. Furthermore, by selectively arranging the particles having vertexes and a larger size than magnetic substance A in the portion near the surface of a carrier core, developing performance can be improved without excessively reducing the resistivity of the carrier core. Since particles having a shape with vertexes are bulky, if such particles are put together, the space between particles tends to be large than that between particles having a shape without vertexes. Therefore, when a magnetic substance having a shape with vertexes is dispersed in a resin, the proportion of the resin part becomes large, with the result that the resistivity of a carrier core increases. In addition, since acute angled convex portions of a low-resistant magnetic substance having vertexes protrude into the surface of a carrier core, a magnetic carrier, even if the magnetic carrier is coated with resin, can satisfactorily attenuate counter charge present in the surface of the magnetic carrier after development, with the result that developing performance is improved. This is because charges easily converge on many convex portions of the magnetic substance protruding into the surface of the carrier core and dissipation of charges starts from the convex potions as origins of internal conduction, facilitating attenuation.

In the surface of a magnetic carrier, convex portions of a magnetic substance having a shape with vertexes are favorably present in a density of 0.8 portions/μm² or more and 2.8 portions/μm² or less, and more favorably in a density of 1.3 portions/μm² or more and 2.5 portions/μm² or less. If the number of convex portions falls within the aforementioned range, charge leakage can be suppressed; at the same time, white spots caused by counter charge can be improved. To obtain such an exposure state of a magnetic substance, the thickness of a resin coating layer is favorably 0.1 μm or more and 1.5 μm or less, and more favorably 0.50 μm or more and 1.00 μm or less. Compared to a large magnetic substance having no vertexes, a large magnetic substance having vertexes has a smaller contact area involved in electrical conduction when magnetic carriers come into contact with each other. Because of this, a magnetic carrier having the above surface appears to have a high electric resistance value in practical use and is presumed to prevent leakage.

In contrast, the magnetic substance A having a relatively small particle diameter can be most closely packed easily since the magnetic substance A has no vertexes. In addition, since the magnetic substance A is present in the interior portion of a carrier core, the electric resistance within the magnetic carrier is presumably low. Accordingly, the electric resistance of the surface is relatively high and the contact resistance between the magnetic carrier particles increases; however, internal electric resistance is low. Thus, it is presumable that the counter charge of the magnetic carrier surface can be satisfactorily attenuated. With such a structure, developing performance at a low electric field strength can be improved while suppressing leakage, and image defects such as white spots can be prevented.

Favorably, the magnetic substance B is more present in the portion near a carrier core surface, and thereby the magnetic substance A occupies the interior portion. A state where the magnetic substance A and B are discretely present in such a manner is favorable for attaining the aforementioned developing performance and leakage at the same time.

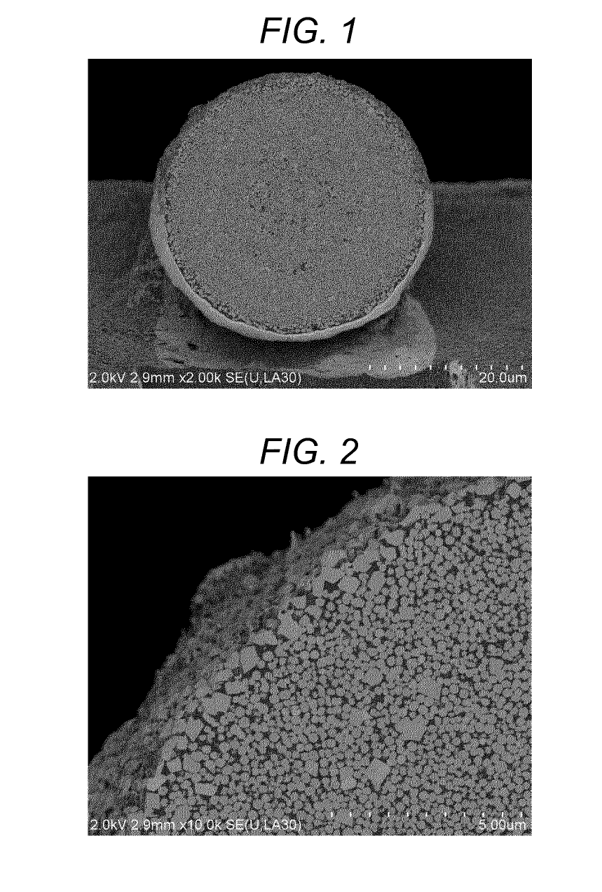

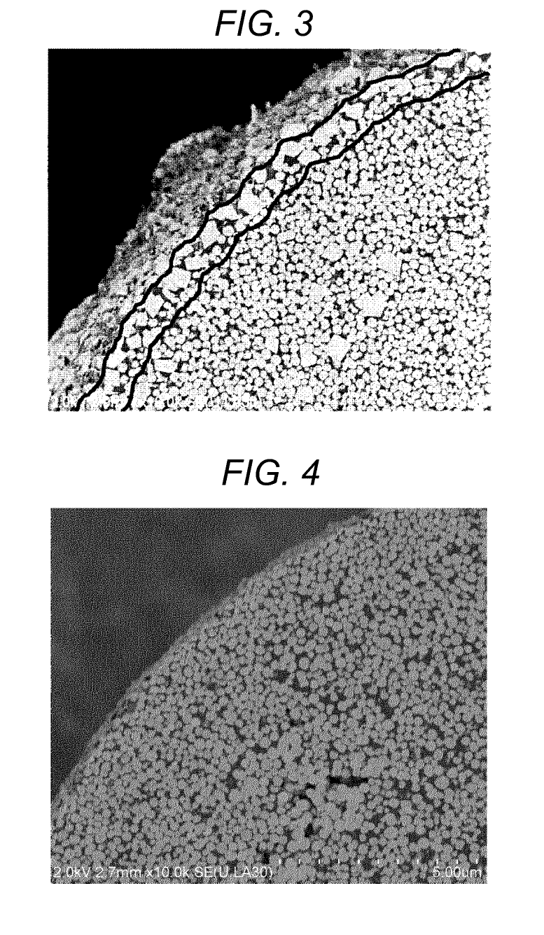

FIG. 1 shows an SEM reflection electron image of a cross section of a carrier core of the present invention by FIB (2000×). An enlarged SEM reflection electron image (10000×) of the portion near the surface of the sectional view of a carrier core in FIG. 1 is shown in FIG. 2. In FIG. 3, lines indicating a region from the surface of the carrier core shown in FIG. 2 to a depth of 1.0 μm are drawn.

In a reflection electron image of a section of the magnetic substance-dispersed resin carrier core taken by a scanning electron microscope, it is important that the area proportion of the magnetic substance B is larger than the area proportion of the magnetic substance A within a region from the carrier core surface to a depth of 1.0 μm. The region from the surface to a depth of about 1.0 μm means the vicinity of the core surface. How large amount of relatively large magnetic substance having a shape with vertexes are present in this portion is an important indication for obtaining characteristics. This is also an indication showing the presence of a binder resin between magnetic substances, because a resin can be easily present more in the space between particles having a shape with vertexes, as described above. That the area proportion of the magnetic substance B is larger than the area proportion of the magnetic substance A refers to the case where the area proportion of the magnetic substance B exceeds 51%, when the sum of a total area of the magnetic substances A having no vertexes and a total area of the magnetic substance B having vertexes is regarded as 100% in the sectional image observed by SEM. Furthermore, the sum is favorably 70% or more.

Furthermore, in the region from the carrier core surface to a depth of 1.0 μm, when the sum of the area of a binder resin portion and the area of a magnetic substance portion is regarded as 100%, the proportion of the binder resin portion is 40 area % or more and 80 area % or less and favorably 50 area % or more and 70 area % or less.

Favorably, in a refection electron image of a section of a carrier core taken by a scanning electron microscope, based on the area proportion of all magnetic substances having a horizontal Feret diameter of 0.10 μm or more in the region from the carrier core surface to a depth of 1.0 μm, the proportion of a magnetic substance having a horizontal Feret diameter of 0.50 μm or more is 70 area % or more. This is more favorable in view of satisfying the above characteristics. Particularly, it is favorable that the magnetic substance having a horizontal Feret diameter of 0.50 μm or more has a shape with vertexes because the amount of the binder resin between the magnetic substances becomes appropriate and attenuation of counter charge against carrier core resistance is facilitated, with the result that the developing performance at a low electric field strength can be enhanced.

On the side near the core deeper than the portion near the carrier core surface, it is favorable that the magnetic substance A having a shape without vertexes are present almost alone in view of improving the electric conductivity within the interior of the magnetic carrier. Accordingly, it is favorable that the magnetic substance A having a shape without vertexes and the magnetic substance B having a shape with vertexes are present in a carrier core as separate layers as much as possible. The content of the magnetic substance B having a shape with vertexes based on the sectional area is favorably 30 area % or less, and more favorably 10 area % or less.

It is necessary that the number average particle diameter of the magnetic substance B is 0.40 μm or more and 2.00 μm or less. If the number average particle diameter falls within the above range, the particles of the magnetic substance B are appropriately bulky and a large amount of resin can be present in a portion near a carrier core surface to increase electric resistance.

Furthermore, the magnetic substance B refers to particles having a shape with vertexes. The phrase “having/with vertexes” means that a particle has vertexes of an angle of 150° or less in a section of a magnetic-substance particle observed by SEM, as mentioned above. Favorably, the vertex has an acute angle, that is, 90° or less. As the shape of a particle becomes closer to a spherical shape, even if the particle is present in the surface, it is difficult to keep a resin. Thus the particles require having a shape with vertexes.

It is favorable that the magnetic substance A has a number average particle diameter of 0.15 μm or more and 0.40 μm or less, because the thickness of a binder resin present between the magnetic substances becomes appropriate, with the result that the carrier core obtains appropriate electric resistance. This is also favorable because the strength of a magnetic carrier is increased to some extent. The number average particle diameter is more favorably 0.20 μm or more and 0.35 μm or less.

Furthermore, the magnetic substance A has a shape without vertexes. The phrase “without/no vertexes” means that a particle has no vertexes of an angle of 150° or less in a section of a magnetic-substance particle observed by SEM, as mentioned above. Because of a virtually spherical shape, the magnetic substance A can be most closely packed, thereby decreasing electric resistance. This is also favorable since the strength of a magnetic carrier is improved.

Favorably, in a refection electron image of a section of a carrier core taken by a scanning electron microscope, based on the area proportion of all magnetic substances having a horizontal Feret diameter of 0.10 μm or more in the region from the carrier core surface to a depth of 1.0 μm, the proportion of a magnetic substance having a horizontal Feret diameter of 0.50 μm or more is 70 area % or more in view of satisfying the above characteristics.

Furthermore, the content of the magnetic substance B is favorably 10% by mass or more and 40% by mass or less with respect to a total amount of the magnetic substance A and the magnetic substance B, and more favorably 25% by mass or more and 35% by mass or less.

The magnetic substance can be produced by a method known in the art such as a wet process and a dry process. For example, a magnetic substance can be produced as follows. First, to a reaction vessel purged with nitrogen gas, an aqueous solution of an alkali hydroxide having a concentration of 2 mole/L or more and 5 mole/L or less and an aqueous solution of iron sulfate and an aqueous solution of zinc sulfate each having a concentration of 0.5 mole/L or more and 2.0 mole/L or less are added so as to satisfy a molar ratio of alkali hydroxide and iron sulfate (mole number of alkali hydroxide/mole number of iron sulfate) of 1.0 or more and 5.0 or less to obtain a mixture solution. Subsequently, alkali hydroxide is further added so as to obtain a desired pH value. While maintaining the mixture solution at a temperature of 70° C. or more and 100° C. or less and blowing oxidizing gas (air) into the above reaction vessel, the mixture solution is stirred and mixed for 7 hours or more and 15 hours or less to produce magnetite. Furthermore, the mixture solution containing magnetite thus produced is filtered, washed with water, dried and pulverized to obtain magnetite. The viscosity of the reaction slurry can be controlled by the concentration of the aqueous iron sulfate solution to be added to the mixture solution. In this manner, the particle diameter distribution of the magnetite to be produced is controlled.

Furthermore, the aqueous iron sulfate solution may contain a bivalent metal ion such as Zn²⁺, Mn²⁺, Ni²⁺, Cr²⁺ or Cu²⁺. As the sources for the above bivalent metal ions, sulfates, chlorides and nitrates thereof are mentioned. Furthermore, SiO₂ may be contained if necessary. Silicate is used as a raw material thereof.

The shape and particle diameter distribution of magnetic-substance particles can be controlled by stirring rate, reaction temperature, pH of the reaction site, reaction time and addition of silicate. The pH value is favorably 8 or more in order to obtain magnetic-substance particles having a shape with vertexes shape. In order to obtain a magnetic-substance particle of an octahedron or an irregular shape, pH is favorably set at 10 or more.

Magnetic-substance particles having other types of vertexes are produced by the following method. After the aforementioned magnetite particles are produced, the magnetite is granulated using polyvinyl alcohol as a binder and baked under reducing atmosphere. Thereafter, these are pulverized and classified to produce magnetic-substance particles having vertexes with controlled particle diameter distribution. Alternatively, hematite, if necessary, zinc oxide, manganese oxide and magnesium hydroxide (desired amounts) are mixed by a ball mill. The mixture is granulated with polyvinyl alcohol as a binder and dried by a spray dryer and baked in an electric furnace at 900° C. for 10 hours. Thereafter, these are pulverized and classified to obtain magnetic-substance particles.

<Carrier Core>

Carrier core will be described.

A carrier core may be produced by either one of a knead-pulverizing process and a polymerization process as long as the carrier core where a magnetic substance is dispersed in a binder resin is obtained. Particularly, in view of controlling the state of presence of the magnetic substance A and the magnetic substance B, a carrier core is favorably produced by a polymerization process.

Examples of the resin include a vinyl resin, a polyester resin, an epoxy resin, a phenol resin, a urea resin, a polyurethane resin, a polyimide resin, a cellulose resin, a silicone resin, an acrylic resin and a polyether resin. The resins may be used alone or as a mixture of two types or more. Particularly, a phenol resin, which can hold relatively large magnetic substance, is favorable because the strength of a carrier core can be increased. In order to increase the magnetic force of a carrier core and further to control the resistivity, the amount of the magnetic substance is increased. More specifically, in the case of a magnetite particle, the addition amount is favorably 80% by mass or more and 90% by mass or less relative to a carrier core.

An aqueous monomer, phenol and aldehyde are subjected to addition polymerization reaction performed in an aqueous medium in the presence of a basic catalyst and hardened as a phenol resol resin. At this time, a magnetic substance is added to the aqueous medium. In this manner, slurry in which the monomer and the magnetic substance are homogenized is obtained. When the resin is hardened in the course of the reaction, the magnetic substance is incorporated to produce a core. Taking advantage of affinity of the aqueous medium for the surface of the magnetic substance, how the magnetic substance is present can be controlled.

To control the state of the presence of the magnetic substance A and the magnetic substance B, it is important to apply a lipophilic treatment to the surface of a magnetic-substance particle prior to producing a carrier core. The lipophilic treatment is performed with a coupling agent such as a silane coupling agent and a titanate coupling agent or by dispersing a magnetic substance in an aqueous solvent containing a surfactant. In this case, by changing the type and amount of treatment agent to the magnetic substance A and the magnetic substance B, the magnetic substance B can be preferentially present in the surface of a carrier core. More specifically, in producing a carrier core in an aqueous medium, the degree of hydrophilicity of the surface of the magnetic substance B is enhanced more than the degree of hydrophilicity of the surface of the magnetic substance A. For example, control can be made by treating the surface of the magnetic substance B with a hydrophilic treatment agent or reducing the amount of lipophilic treatment agent applied to the magnetic substance B compared with the amount of lipophilic treatment agent applied to the magnetic substance A.

The resistivity of the magnetic substance A and B at an electric field strength of 1000 V/cm is favorably 1.0×10³ Ω·cm or more and 1.0×10⁶ Ω·cm or less.

The magnetization intensity of the magnetic substance A and B at 79.6 kA/m (1000 oersted) is favorably 60 Am²/kg or more and 75 Am²/kg or less.

The carrier core favorably has a 50% particle diameter on a volume basis of 19.0 μm or more and 69.0 μm or less. Owing to this, a 50% particle diameter of the magnetic carrier on a volume basis can be set at 20.0 μm or more and 70.0 μm or less. The 50% particle diameter of the carrier core on a volume basis can be controlled by controlling granulation conditions which is controlled by the stirring speed and slurry concentration during a polymerization reaction.

The resistivity of a carrier core at an electric field strength of 1000 V/cm is favorably 1.0×10⁶ Ω·cm or more and 1.0×10⁸ Ω·cm or less and more favorably 8.0×10⁶ Ω·cm or more and 8.0×10⁷ Ω·cm or less in view of enhancing developing performance.

As a magnetic property of a carrier core, the magnetization intensity at a magnetic field of 79.6 kA/m (1000 oersted) is favorably 50.0 Am²/kg or more and 70.0 Am²/kg or less.

<Resin Coating Layer>

The coating resin to be used in a coating layer is not particularly limited; however, a vinyl resin, which is a copolymer between a vinyl monomer having a cyclic hydrocarbon group in a molecular structure and another vinyl monomer, is favorable. A reduction of charge quantity under a high temperature and high humidity environment can be suppressed by coating with the vinyl resin.

Specific examples of the cyclic hydrocarbon group include cyclic hydrocarbon groups having 3 to 10 carbon atoms such as a cyclopropyl group, a cyclobutyl group, a cyclopentyl group, a cyclohexyl group, a cycloheptyl group, a cyclooctyl group, a cyclononyl group, a cyclodecyl group, an adamantyl group, a norbornyl group and an isobornyl group. Of them, a cyclohexyl group, a cyclopentyl group and an adamantyl group are favorable and a cyclohexyl group is particularly favorable in view of a stable structure, high adhesion to a core, and development of release property.

Furthermore, to control glass transition temperature (Tg), another monomer may be added as a vinyl resin component.

As the other monomer to be used as a vinyl resin component, a monomer known in the art is used. Examples of the monomer are as follows: styrene, ethylene, propylene, butylene, butadiene, vinyl chloride, vinylidene chloride, vinyl acetate, methyl methacrylate, ethyl methacrylate, propyl methacrylate, vinyl methyl ether, vinyl ethyl ether and vinyl methyl ketone.

Furthermore, it is favorable that the vinyl resin to be used as a coating layer is a graft polymer since a uniform coating layer is formed.

A graft polymer is obtained by a method of graft polymerization performed after formation of the main chain or a copolymerization method using a macro monomer as a monomer. The copolymerization method using a macro monomer is favorable since the molecular weight of a branched chain can be controlled in advance. The number average molecular weight of a graft portion is favorably 2000 or more and 10000 or less, and more favorably, 4000 or more and 6000 or less in order to improve adhesion.

The macro monomer to be used is not particularly limited; however, a methyl methacrylate macro monomer is favorable since the charge quantity under a high temperature and high humidity environment is increased.

The amount of macro monomer for use in polymerization is favorably 10 to 50 parts by mass, and more favorably, 20 to 40 parts by mass relative to 100 parts by mass of the (co)polymer of the main chain of a vinyl resin.

Furthermore, a resin coating layer may contain a particle having conductivity and a particle and material having charge controllability in addition to a coating resin. As the particle having conductivity, carbon black, magnetite, graphite, zinc oxide and tin oxide are mentioned.

The addition amount of particle and material having conductivity is favorably 0.1 part by mass or more and 10.0 parts by mass or less relative to 100 parts by mass of the coating resin in order to control the resistance of a magnetic carrier.

Examples of the particle and material having charge controllability include particles of organic metal complexes, particles of organic metal salts, particles of chelate compounds, particles of monoazo metal complexes, particles of acetyl acetone metal complexes, particles of hydroxycarboxylic acid metal complexes, particles of polycarboxylic acid metal complexes, particles of polyol metal complexes, particles of polymethyl methacrylate resins, a polystyrene resin particle, a melamine resin particle, a phenol resin particle, a nylon resin particle, a silica particle, a titanium oxide particle and an alumina particle.

The addition amount of particle and material having charge controllability is favorably 0.5 parts by mass or more and 50.0 parts by mass or less relative to 100 parts by mass of the coating resin in order to control triboelectric charge quantity.

The addition amount of coating resin composition containing a coating resin and other additional materials is favorably 0.1 part by mass or more and 5.0 parts by mass or less relative to 100 parts by mass of the carrier core in order to prevent leakage and improve developing performance at low electric field strength. The addition amount thereof is more favorably 1.0 part by mass or more and 3.0 parts by mass or less.

The method for applying a coating resin composition is not particularly limited. Examples of the coating method include a soaking method, a kneading method, a spray method, a brush application method, a dry process and an application method using a fluidized bed or the like. Of them, a soaking method, a kneading method or a dry process is favorable since the angular portions of a magnetic substance having vertexes are not completely covered.

<Magnetic Carrier>

The 50% particle diameter (D50) of the magnetic carrier on a volume distribution basis is favorably 20.0 μm or more and 70.0 μm or less. By virtue of this, the image quality of a half tone portion can be improved and also carrier adhesion can be satisfactorily suppressed.

It is favorable that a magnetic carrier has a resistivity at an electric field strength of 1000 V/cm of 7.0×10⁷ Ω·cm or more and 1.0×10¹⁰ Ω·cm or less in view of enhancing developing performance at a low electric field strength to obtain an image having no white spots. A magnetic carrier together with a toner is exposed to a higher electric field strength in a development field. However, since a toner is an insulting substance, a strong electric field is predominantly applied. For the reason, the strength of the electric field applied on a magnetic carrier is presumably as low as about 1000 V/cm. Therefore, the present inventors employ the resistivity at an electric field strength of 1000 V/cm in the resistivity measurement method.

When the resistivity of the magnetic substance-dispersed resin carrier core at 1000 V/cm is represented by Rk and the resistivity of the magnetic carrier at 1000 V/cm is represented by Rc, Rk and Rc favorably satisfy

0.5≦Rc/Rk≦70.0

in order to maintain developing performance at a low electric field strength during long-term repeated use.

The true specific gravity of the magnetic carrier is favorably 3.0 g/cm³ or more and 4.0 g/cm³ or less in order to reduce toner spent during long time repeated use.

As the magnetic properties of the magnetic carrier, a magnetization intensity at 79.6 kA/m (1000 oersted) is favorably 50 Am²/kg or more and 70 Am²/kg or less, and more favorably 55 Am²/kg or more and 65 Am²/kg or less.

<Toner>

Next, a toner contained together with a magnetic carrier in a two-component developer will be described.

Examples of a method for producing particles of the toner to be used in the present invention include,

i) a pulverizing method in which a binder resin, a colorant and a wax are melted and kneaded, and a kneaded product is cooled, pulverized and classified,

ii) a suspension granulation method in which a binder resin and a colorant are dissolved or dispersed in a solvent, the resultant solution is added to an aqueous medium to suspend and granulate, and then the solvent is removed to obtain toner particles,

iii) a suspension polymerization method in which a monomer composition having a colorant and others homogeneously dissolved or dispersed in a monomer and a dispersion stabilizer are dispersed in a continuous layer (for example, a water phase) and a polymerization reaction is performed to prepare toner particles,

iv) a dispersion polymerization method in which a monomer is polymerized in an aqueous organic solvent having a polymer dispersant dissolved therein to produce a particle (toner particle) insoluble in the solvent,

v) an emulsion polymerization method in which direct polymerization is performed in the presence of a water soluble polar polymerization initiator to produce a toner particle, and

vi) an emulsion aggregation method for obtaining toner particles including a step of aggregating at least a polymer fine particle and a colorant fine particle to form a fine particle aggregate and a step of aging the fine particles of the fine particle aggregation to fuse them.

Particularly, the toner obtained by the pulverizing method is favorable since inorganic fine particles having a large particle diameter of about 100 nm, which tend to separate after long time repeated used, are fixed by adding the inorganic fine particles to the toner after pulverizing or after pulverizing/classification and modifying the surface of the toner by a thermal treatment. Note that, if large particle diameter inorganic fine particles are fixed, the spacer effect is produced to improve transfer performance.

As the shape of a toner, it is favorable that an average circularity is 0.945 or more and 0.985 or less in view of developing performance, transfer performance and cleaning performance. Further favorably, an average circularity is 0.950 or more and 0.980 or less.

Examples of the binder resin to be contained in a toner are as follows: polyester, polystyrene; polymers of styrene derivatives such as poly-p-chlorostyrene and polyvinyl toluene; styrene copolymers such as a styrene-p-chlorostyrene copolymer, a styrene-vinyl toluene copolymer, a styrene-vinyl naphthalene copolymer, a styrene-acrylate copolymer, a styrene-methacrylate copolymer, a styrene-methyl α-chloromethacrylate copolymer, a styrene-acrylonitrile copolymer, a styrene-vinyl methyl ketone copolymer, a styrene-butadiene copolymer, a styrene-isoprene copolymer and a styrene-acrylonitrile-indene copolymer; polyvinyl chloride, a phenol resin, a modified phenol resin, a maleic resin, an acrylic resin, a methacrylic resin, polyvinyl acetate resin, a silicone resin; a polyester resin having a monomer selected from an aliphatic polyhydric alcohol, an aliphatic dicarboxylic acid, an aromatic dicarboxylic acid, an aromatic dialcohol and a diphenol, as a structural unit; a polyurethane resin, a polyamide resin, polyvinyl butyral, a terpene resin, a cumarone indene resin, a petroleum resin and a hybrid resin having a polyester unit and a vinyl polymer unit.

In the binder resin, it is favorable that the peak molecular weight (Mp) in a molecular weight distribution is 2,000 or more and 50,000 or less; a number average molecular weight (Mn) is 1,500 or more and 30,000 or less; a weight average molecular weight (Mw) is 2,000 or more and 1,000,000 or less; and a glass transition point (Tg) is 40° C. or more and 80° C. or less, which are measured by a gel permeation chromatography (GPC), in order to maintain balance between storage stability and low temperature fixation of a toner.

It is favorable to use wax in an amount of 0.5 parts by mass or more and 20.0 parts by mass or less per 100 parts by mass of a binder resin since an image having high glossiness can be provided. Furthermore, the peak temperature of a maximum endothermic peak of a wax is favorably 45° C. or more and 140° C. or less. This is favorable since balance between the storage stability of a toner and hot offset resistance can be maintained.

Examples of a wax are as follows: hydrocarbon waxes such as a low molecular weight polyethylene, a low molecular weight polypropylene, an alkylene copolymer, a microcrystalline wax, a paraffin wax and Fischer-Tropsch wax; oxides of a hydrocarbon wax such as an oxidized polyethylene wax or a block copolymer thereof; waxes containing an fatty acid ester such as carnauba wax, behenic acid behenyl ester wax and montanic acid ester wax, as a main component; and wholly or partially deoxidized fatty acid esters such as deoxidized carnauba wax. Of them, a hydrocarbon wax such as Fischer-Tropsch wax is favorable since an image having high glossiness can be provided.

As the colorant to be contained in a toner, the following ones are mentioned.

Examples of a black colorant include carbon black and a magnetic substance. A black colorant may be prepared from a yellow colorant, a magenta colorant and a cyan colorant.

Examples of the magenta colorant include a condensed azo compound, a diketo-pyrrolo-pyrrole compound, anthraquinone, quinacridone compound, a basic dye lake compound, a naphthol compound, a benzimidazolone compound, a thioindigo compound and a perylene compound.

Examples of the cyan colorant include C. I. Pigment blue 1, 2, 3, 7, 15:2, 15:3, 15:4, 16, 17, 60, 62, 66; C. I. vat blue 6, C. I. acid blue 45 and a copper phthalocyanine pigment having a phthalocyanine skeleton with 1 to 5 phthalimide methyl substituents.

Examples of the yellow colorant include a condensed azo compound, an isoindolinone compound, an anthraquinone compound, an azo metal compound, a methine compound and an allylamide compound.

As a colorant, a pigment may be used alone; however, it is more favorable that a dye and a pigment are used in combination to improve the definition of the color in view of the quality of full color image.

The use amount of colorant, except the case where a magnetic substance is used, is favorably 0.1 part by mass or more and 30.0 parts by mass or less relative to 100 parts by mass of the binder resin and more favorably 0.5 parts by mass or more and 20.0 parts by mass or less.

To a toner, if necessary, a charge controlling agent can be added. As the charge controlling agent to be added to a toner, those known in the art can be used; however it is particularly favorable to use a metal compound of aromatic carboxylic acid, which is colorless and allows toner to be charged at a high speed and can stably maintain a predetermined charge quantity.

A charge controlling agent may be internally added or externally added to a toner particle. The addition amount of charge controlling agent is favorably 0.2 parts by mass or more and 10.0 parts by mass or less relative to 100 parts by mass of the binder resin.

It is favorable that additives are externally added to a toner in order to improve flowability. As the additive to be externally added, inorganic fine particles such as silica, titanium oxide and aluminum oxide are favorable. The inorganic fine particles are favorably hydrophobized with a hydrophobizing agent such as a silane compound, silicone oil or a mixture of these. The additive to be externally added is favorably used in an amount of 0.1 part by mass or more and 5.0 parts by mass or less relative to 100 parts by mass of the toner particles. Toner particles and the additive to be externally added can be mixed with a mixer known in the art such as a Henschel mixer.

A two-component developer is favorably prepared by adding a toner to a magnetic carrier in a ratio of 2 parts by mass or more and 15 parts by mass or less relative to 100 parts by mass of the magnetic carrier, and more favorably, 4 parts by mass or more and 12 parts by mass or less. If the ratio falls within the above range, scattering of toner can be reduced and triboelectric charge quantity can be stabilized for a long time.

Furthermore, if the two-component developer is used as a supplemental developer, the mixing ratio of a toner relative to a magnetic carrier is favorably 2 parts by mass or more and 50 parts by mass or less relative to 1 part by mass of the magnetic carrier and more favorably 4 parts by mass or more and 20 parts by mass or less. If the mixing ratio falls within the above range, the triboelectric charge quantity can be stably obtained, and further advantageously, the frequency of exchanging a supplemental developer, which is burden to the user, can be reduced.

A supplemental developer is prepared by weighing desired amounts of magnetic carrier and toner and mixing these by a mixer. Examples of the mixer include a double con-mixer, a V-shape mixer, a drum mixer, a super mixer, a Henschel mixer and a Nauta mixer. Of them, a V-shape mixer is favorable in view of dispersiveness of a magnetic carrier.

How to measure physical properties according to the present invention will be described below.

<Method for Determining 50% Particle Diameter (D50) on a Volume Distribution Basis of Magnetic Carrier and Carrier Core>

A particle diameter distribution is determined by laser diffraction/scattering system particle diameter distribution measurement apparatus “Microtrack MT3300EX” (manufactured by Nikkiso Co., Ltd.).

Determination of 50% particle diameter (D50) on a volume distribution basis of a magnetic carrier and a carrier core is made by attaching a sample supplier for a dry process measurement “one shot dry sample conditioner Turbotrac” (manufactured by Nikkiso Co., Ltd). Supply conditions by Turbotrac are as follows: a dust collector is used as a vacuum source (air capacity: about 33 liters/sec, pressure: about 17 kPa). Control is automatically performed through software. As the particle diameter, a 50% particle diameter (D50), which is a cumulative value on a volume distribution basis, is obtained. Control and analysis are made by use of the accompanying software (version 10.3.3-202D). Measurement conditions are as follows.

Set Zero time: 10 seconds

Measurement time: 10 seconds

Measurement times: Once

Particle refractive index: 1.81

Particle shape: Spherical

Upper limit of measurement: 1408 μm

Lower limit of measurement: 0.243 μm

Measurement environment: 23° C./50% RH

<Method for Determining Number Average Particle Diameter of Magnetic Substance>

The particle diameter distribution of a magnetic substance is determined by use of a magnetic substance before a carrier core is produced. When the distribution is determined from a magnetic carrier, a coating resin composition is removed with chloroform from the magnetic carrier and the resultant carrier core is put on an alumina boat, baked in a muffle furnace at 600° C. for one hour and minced in an agate mortar. The particles thus obtained are measured.

A magnetic substance is observed by a scanning electron microscope (SEM), S-4800 (manufactured by Hitachi High-Technologies Corporation) under the following conditions.

SignalName=SE (U, LA80)

AcceleratingVoltage=2000 Volt

EmissionCurrent=11000 nA

WorkingDistance=8000 um

LensMode=High

CondenSer1=5000

ScanSpeed=Capture Slow (20)

Magnification=30000 (used for measurements)

DataSize=1280×960

ColorMode=Grayscale

SpecimenBias=0V

Note that, a reflection electron image is obtained as a 256-gradation gray scale image under the above conditions by controlling contrast to be 5 and brightness to be −5 on the control software of a scanning electron microscope S-4800 and turning off a magnetic substance observation mode.

Subsequently, the obtained image is printed out on an A3 paper sheet as an enlarged image. The horizontal Feret diameter is measured. The horizontal Feret diameter measured is converted into an actual length (diameter) with reference to the scale on the picture. The particle diameters thus measured are classified into 16 columns: (0.016 μm-0.023 μm), (0.023 μm-0.033 μm), (0.033 μm-0.047 μm), (0.047 μm-0.066 μm), (0.066 μm-0.094 μm), (0.094 μm-0.133 μm), (0.133 μm-0.187 μm), (0.187 μm-0.265 μm), (0.265 μm-0.375 μm), (0.375 μm-0.530 μm), (0.530 μm-0.750 μm), (0.750 μm-1.060 μm), (1.060 μm-1.499 μm), (1.499 μm-2.121 μm), (2.121 μm-2.999 μm), (2.999 μm-4.241 μm), to obtain a particle diameter distribution. As a number average particle diameter, an arithmetic average particle diameter is used.

More specifically, when a number average particle diameter is calculated, all particles are classified into the above columns and a medium value of each column (representative particle diameter) is obtained and multiplied by a relative amount of particles (delta %) and then divided by the total of relative amounts of particles (100%).

First, the particle diameter range (a maximum particle diameter: x₁, a minimum particle diameter: xₙ₊₁) to be measured is divided by n. Individual particle diameter zones are designated as [xⱼ, xⱼ₊₁] (j=1, 2, . . . , n). In this case, division is made equally on the logarithmic scale. Furthermore, based on the logarithmic scale, the representative particle diameter per particle diameter zone is expressed by the following expression.

$$\frac{{log}_{10} {x}_{1} + {log}_{10} {x}_{i + 1}}{2} \qquad Expression 1$$

Furthermore, assuming that rⱼ (j=1, 2, . . . , n) is defined as a relative amount of particles (delta %) corresponding to a particle diameter zone [xⱼ, xⱼ₊₁] and the total of all zones is regarded as 100%, an average value μ on the logarithmic scale can be calculated in accordance with the following expression.

$$μ = \frac{1}{100} {\sum }_{j = 1}^{n} {r}_{j} ( \frac{{log}_{10} {x}_{j} + {log}_{10} {x}_{j + 1}}{2} ) \qquad Expression 2$$

The symbol μ represents a numerical value on the logarithmic scale and has no unit as a particle diameter. Thus, to convert μ into a unit of a particle diameter, 10^{μ}, that is, 10 to the μth power is calculated. The value of 10^{μ} is regarded as a number average particle diameter.

<Method for Calculating the Area Proportion of Magnetic Substance a and Magnetic Substance B in the Region from the Surface of the Carrier Core to a Depth of 1.0 μm>

A carrier core can be sectioned by use of a focused ion beam process observation apparatus (FIB), FB-2100 (manufactured by Hitachi High-Technologies Corporation). The carrier core used herein is prepared by previously treating a magnetic carrier with chloroform to remove a coating layer.

A sample is prepared by applying carbon paste onto side surfaces of end portions of a cutout mesh for FIB, adhering a small amount of carrier core particles thereto so as to be discretely present from each other and depositing platinum thereon to form a conductive film. The carrier core to be sectioned is selected at random from particles having a size falling within the range of ±10% of the 50% particle diameter (D50) on a volume distribution basis.

Note that, a sample is sectioned such that the section finally obtained has virtually a maximum diameter in a sectioning direction. To describe more specifically, the distance between a position in a flat surface including a maximum length of a particle in the direction parallel to the adhesion surface of the sample and the adhesion surface is specified as h (For example, in the case of a complete spherical shape having a radius r, h=r). A sample is sectioned in the direction perpendicular to the adhesion surface within the range of h±10% distance (for example, in the case of a complete spherical shape having a radius r, the range is the distance of r±10% from the adhesion surface).

A sample is sectioned at an acceleration voltage of 40 kV, by use of a Ga ion source at a beam current of 39 nA (for rough cutting) and at a beam current of 7 nA (for finish cutting).

The sample section can be directly observed by a scanning electron microscope (SEM). In the observation by the scanning electron microscope, the emission amount of reflection electrons varies depending on the atomic numbers of substances constituting the sample. Thus, an image showing the composition of the carrier core section can be obtained. In the observation of the carrier core section, a region of a heavy element derived from a magnetic substance, for example, a magnetite component, looks bright (looks white since brightness is high); whereas a region of a light element derived from a resin component or a void looks dark (looks black since brightness is low). The site to be measured is a site near “carrier core surface”, more specifically the left-side portion of the surface to which a beam is first applied in FIB processing (in FIG. 1, the second quadrant counterclockwise when the section of a particle is divided into 4 quarters). Furthermore, the inside of the particle refers to a region of a 4 μm-square (16 μm²) including the center of a particle section.

More specifically, observation conditions by a scanning electron microscope (SEM), S-4800 (manufactured by Hitachi High-Technologies Corporation) are as follows.

SignalName=SE (U, LA30)

AcceleratingVoltage=2000 Volt

EmissionCurrent=10000 nA

WorkingDistance=8000 um

LensMode=High

CondenSer1=12

ScanSpeed=40 sec

Magnification=10000 (used for measurements)

DataSize=1280×960

ColorMode=Grayscale

SpecimenBias=0 V

A reflection electron image is obtained as a 256-gradation gray scale image under the above conditions by controlling contrast to be 5 and brightness to be −5 on the control software of a scanning electron microscope 5-4800 and turning off a magnetic substance observation mode.

Subsequently, at a site on the obtained image at a distance of 1.0 μm inward from the surface of the carrier core, a trace line of the carrier core surface is drawn. Of the regions partitioned by the trace line, in the region near the surface, the ratio of the area of binder resin portions to the area of magnetic-substance particle portions is obtained. This processing may be performed by use of an image processing software or by use of an image printed out on a paper sheet.

More specifically, the process can be carried out by the following method.

On the gray scale image mentioned above, a trace line is drawn by use of PowerPoint (manufactured by Microsoft). The image is printed out on an A3 paper sheet. A tracing paper sheet is superposed on the image printed out and an outline and the trace line are transferred, and further, the magnetic substance A and the magnetic substance B are completely filled with different colors.

Next, the magnetic-substance particles on the tracing paper sheet are captured by a camera. The image thus captured is analyzed by use of image analysis software Image-ProPlus (manufactured by MediaCybernetics, ver 5.1.1.32) to computationally obtain the area proportion occupied by each particle.

Area proportion of the magnetic substance B (area %)=the total area of the magnetic substance B/(the total area of the magnetic substance A+the total area of the magnetic substance B)×100

This measurement operation is repeated with respect to 10 carrier core particles and an average area proportion (area %) of the magnetic substance B near the carrier core surface is computationally obtained.

<Method for Calculating the Area Proportion of a Binder Resin Portion and a Magnetic Substance Portion in the Region from the Carrier Core Surface to a Depth of 1.0 μm>

The area proportion of a binder resin portion and a magnetic substance portion in the region from the carrier core surface to a depth of 1.0 μm is calculated based on the measurement performed by using the carrier core section used in <Method for calculating the area proportion of magnetic substance A and magnetic substance B in the region from the surface of the carrier core to a depth of 1.0 μm> mentioned above, as a site near “carrier core surface”, more specifically, a site to which a beam is not applied in FIB processing, i.e., the lower left side (in FIG. 1, the third quadrant in 4 quarters when the section of a particle is divided into 4 quarters).

Operation after a reflection electron image is obtained is performed in the same manner as described in <Method for calculating the area proportion of magnetic substance A and magnetic substance B in the region from the surface of the carrier core to a depth of 1.0 μm>. The area proportion of the binder resin portion and the magnetic substance portion is calculated according to the following expression.

Area proportion of the binder resin portion (area %)={(the area of the region from the surface to a depth of 1 μm−the sum of areas of the magnetic substances)/the area of the region from the surface to a depth of 1 μm}×100

This measurement operation is repeated with respect to 10 carrier core particles and an average area proportion (area %) of the binder resin near the carrier core surface is computationally obtained.

<Method for Calculating the Area Proportion of Magnetic Substance B within Carrier Core>

The area proportion of the magnetic substance B within the carrier core is calculated based on the measurement, which is performed in the same manner as in obtaining the area proportion of the magnetic substance B near the surface as mentioned above. The measurement site is specified as an area of 4 μm×4 μm including the center of a carrier particle used in the above. More specifically, the area is defined as follows.

In the particle section, a center is defined as an intersection between line A having a maximum length and line B which is crossed perpendicularly with the line A and has a maximum length. Measurement is performed in a square (16 μm²) area surrounded by two parallel lines at a distance of 2 μm from the line A and two parallel lines at a distance of 2 μm from the line B.

Area proportion of the magnetic substance B (area %)=the total area of the magnetic substances B/(the total area of the magnetic substance A+the total area of the magnetic substance B)×100

This measurement operation is repeated with respect to 10 core particles and an average area proportion (area %) of the magnetic substances B within the core is computationally obtained.

<Method for Calculating the Content of Particles Having a Horizontal Feret Diameter of 0.50 μm or More in the Region from the Carrier Core Surface to a Depth of 1.0 μm>

An image of a portion near a carrier core surface on the above tracing paper sheet is analyzed by use of image analysis software Image-ProPlus (manufactured by MediaCybernetics, ver 5.1.1.32) to extract particles having a horizontal Feret diameter of 0.10 μm or more. In this case, the content of particles having a horizontal Feret diameter 0.10 μm or more is calculated regardless of the shape of the particles.

The content of particles of 0.50 μm or more (area %)=the sum of areas of particles of 0.50 μm or more/(the total area of the magnetic substance portions having a horizontal Feret diameter of 0.10 μm)×100

This measurement operation is repeated with respect to 10 carrier core particles and an average area proportion (area %) of the particles having a horizontal Feret diameter of 0.50 μm or more is computationally obtained.

<Method for Checking the Shape of Magnetic-Substance Particle>

In a method for checking the shape of a magnetic-substance particle, a sample obtained by the aforementioned FIB section processing is observed by a scanning electron microscope (SEM), and the number of particles having no vertexes of an angle of 150° or less and the number of particles having vertexes of an angle of 150° or less are separately counted. More specifically, using an image magnified to 30000 times, with respect to magnetic-substance particles having a maximum sectional diameter of 0.1 μm or more, angles formed between virtually linear edges (0.05 μm or more) are observed.

<Method for Counting the Number of Convex Portions of Magnetic Substances in the Magnetic Carrier Surface>

The convex portions of magnetic substances in the magnetic carrier surface are counted under observation by a scanning electron microscope (SEM). In the observation by the scanning electron microscope, the emission amount of reflection electrons varies depending on the atomic numbers of substances constituting the sample. Thus, an image showing the composition of the magnetic carrier can be obtained. In the observation of the surface of a magnetic carrier, a region of a heavy element derived from a magnetic substance, for example, a magnetite component, looks bright (looks white since brightness is high); whereas a region of a light element derived from a resin component looks dark (looks black since brightness is low). Furthermore, in the case where the surface is formed of a resin and a magnetic substance is present inside the surface, an intermediate color density (gray) between black and white is shown. In measuring, the center of the viewing field is controlled to meet with the head of a magnetic carrier.

More specifically, a magnetic carrier is observed by a scanning electron microscope (SEM), S-4800 (manufactured by Hitachi High-Technologies Corporation) under the following conditions.

SignalName=SE (U, LA30)

AcceleratingVoltage=2000 Volt

EmissionCurrent=10000 nA

WorkingDistance=8000 um

LensMode=High

CondenSer1=12

ScanSpeed=40 sec

Magnification=10000 (used for measurements)

DataSize=1280×960

ColorMode=Grayscale

SpecimenBias=0V

Note that, a reflection electron image is obtained as a 256-gradation gray scale image under the above conditions by controlling contrast to be 5 and brightness to be −5 on the control software of a scanning electron microscope S-4800 and turning off a magnetic substance observation mode.

In the obtained image, “regions (white portion) of a heavy element derived from a magnetite component” present in a 5-μm square are counted and divided by 25. This is the number of convex portions (portions/μm²) of a magnetic substance in the magnetic-carrier surface. In this case, as regions of a heavy element derived from a magnetite component (white portion), regions having a maximum diameter of 0.2 μm or more (white portion) are counted. This measurement is performed by selecting 10 particles at random from the particles having a size falling within the range of ±10% of the 50% particle diameter (D50) on a volume distribution basis.

<Resistivity of Magnetic Carrier, Carrier Core and Magnetic Substance>

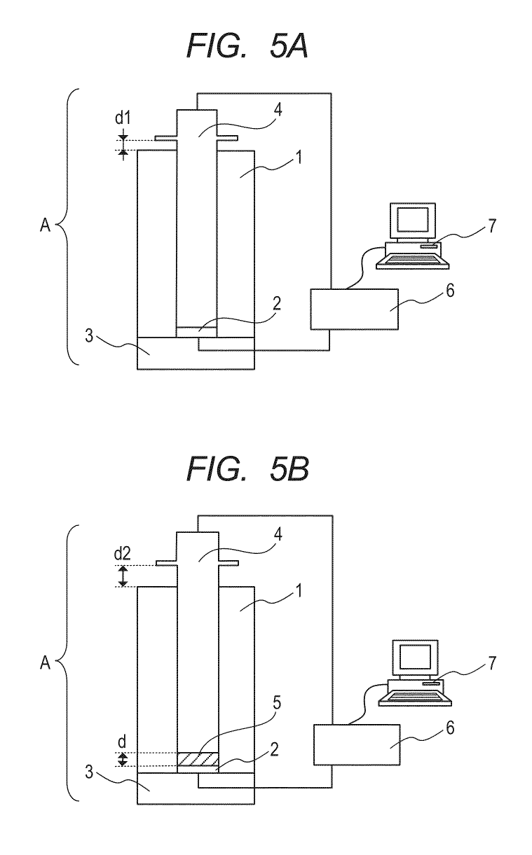

Resistivity of a magnetic carrier, a carrier core and a magnetic substance is measured by the measurement apparatus schematically shown in FIG. 5A and FIG. 5B.

Note that, resistivity of a carrier core is measured by using a sample before resin coating. Alternatively, the coating layer of a coated magnetic carrier is dissolved with chloroform and the resultant magnetic carrier is dried and then put in use.

Resistance measurement cell A is constituted of a perforated cylindrical PTFE resin container 1 having a sectional area of 2.4 cm², a lower electrode (made of stainless steel) 2, a support base (made of a PTFE resin) 3 and an upper electrode (made of stainless steel) 4. The cylindrical PTFE resin container 1 is mounted on the support base 3, and filled with about 0.7 g of a sample 5 (magnetic carrier, carrier core, or magnetic substance). On the sample 5 filled, the upper electrode 4 is placed to measure the thickness of the sample. When the initial thickness (no sample is placed) previously measured is represented by d1 (blank), the true thickness of the sample (about 0.7 g) filled is represented by d, and the thickness of the sample measured is represented by d2 (sample), the true thickness d of the sample is expressed by the following equation.

d=d2 (sample)−d1 (blank)

The resistivity of a magnetic carrier, a carrier core and a magnetic substance can be obtained by applying a voltage between the electrodes and measuring a current flowing at that time. The resistivity is measured by an electrometer 6 (Keithley 6517 manufactured by Keithley Instruments) and a control computer 7.

Measurement conditions are follows: contact area S of a sample (magnetic carrier, carrier core and magnetic substance) with an electrode is set at 2.4 cm², and load on the upper electrode is set at 230 g (2.25 N).

Application conditions of voltage are as follows. An IEEE-488 interface is used for controlling between the control computer and the electrometer. Using automatic range function of the electrometer, screening is performed by applying voltages of 1V, 2V, 4V, 8V, 16V, 32V, 64V, 128V, 256V, 512V and 1000V independently for one second. At this time, whether voltage application can be made up to a maximum 1000 V (for example, electric field strength is 10000 V/cm in the case of a sample 1.00 mm in thickness) is determined by the electrometer. If overcurrent flows, a lamp of “VOLTAGE SOURCE OPERATE” blinks. If so, the application voltage is reduced and applicable voltage is further screened. In this manner, a maximum application voltage is automatically determined. Thereafter, actual measurement is performed. A voltage, which is obtained by dividing maximum voltage value by 5, is applied and maintained for 30 seconds in each step and thereafter a current value is measured to determine a resistance value. More specifically, if a maximum application voltage is 1000 V, a voltage is applied stepwise at the intervals of 200 V, which is ⅕ of the maximum application voltage, in the ascending order like 200 V (first step), 400 V (second step), 600 V (third step), 800 V (fourth step) and 1000 V (fifth step) and then in descending order like 1000 V (sixth step), 800 V (seventh step), 600 V (eighth step), 400 V (ninth step) and 200 V (tenth step). The voltage is maintained for 30 seconds in each step and then the current value is measured to determine the resistance value.

The resistance values are processed by the computer to calculate electric field strength and resistivity and then plotted to obtain a graph. Resistivity at an electric field strength of 1000 V/cm is read out from the graph.

Note that, resistivity and electric field strength are obtained from the following equation.

Resistivity (Ω·cm)=(application voltage (V)/measured current (A))×S (cm²)/d (cm)

Electric field strength (V/cm)=application voltage (V)/d (cm)

<Method for measuring true specific gravity of Magnetic Carrier>

The true specific gravity of the magnetic carrier according to the present invention is determined by using a dry process automatic densitometer autopicnometer (manufactured by Yuasa Ionics Inc.).
Cell: SM cell (10 mL)
Amount of sample: 2.0 g

In the method, the true density of a solid or liquid substance is measured based on a gas phase substitution method based on the Archimedes' principle similarly to a liquid phase substitution method. Since He gas is used as substitution medium, the measurement precision of a magnetic carrier using a magnetic substance-dispersed resin core is high.

<Method for Measuring Magnetization Intensity of Magnetic Carrier, Carrier Core and Magnetic Substance>

The magnetization intensity of a magnetic carrier can be obtained by an oscillating field magnetic property measurement apparatus (Vibrating sample magnetometer) or a direct current magnetic characteristic recording apparatus (B-H tracer). In the present invention, measurement is made by use of an oscillating field magnetic property measurement apparatus BHV-30 (manufactured by Riken Denshi Co., Ltd.) in the following procedure.

The magnetizing moment at an external magnetic field of 79.6 kA/m (1000 oersted) is measured by use of a cylindrical plastic container sufficiently densely filled with a magnetic carrier as a sample. In measurement, a maximum positive external magnetic field (+79.6 kA/m) is applied and thereafter a maximum negative external magnetic field (−79.6 kA/m) is applied to make a hysteresis loop. The average of absolute values of positive and negative maximum values is obtained and defined as a maximum magnetizing moment (emu). In addition, the actual mass of the magnetic carrier filling in the container is measured. The maximum magnetizing moment is divided by mass (g) to obtain the magnetization intensity (Am²/kg) of the magnetic carrier. The magnetization intensity of each of a carrier core and a magnetic substance is obtained in the same manner.

<Method of Determining Weight Average Particle Diameter (D4) and Number Average Particle Diameter (D1) of Toner>

The weight average particle diameter (D4) and the number average particle diameter (D1) of toner are calculated as follows. As a measurement apparatus, an accurate particle diameter distribution measurement apparatus “Coulter•counter Multisizer 3” (registered trade mark, manufactured by Beckman•Coulter) equipped with a 100 μm-aperture tube based on a pore electrical resistance method is used. For setting measurement conditions and analyzing measurement data, the accompanying special software “Beckman•Coulter Multisizer 3 Version3. 51” (manufactured by Beckman•Coulter) is used. Note that, measurement is performed by using effective 25000 measuring channels.

The aqueous electrolyte solution for use in measurement is prepared by dissolving special grade sodium chloride in ion exchanged water up to a concentration of about 1% by mass. For example, “ISOTON II” (manufactured by Beckman•Coulter) can be used.

Note that, before measurement and analysis, the special software is set as follows.

In the setting screen of “change standard operation method (SOM)” of the special software, the total count number in control mode is set at 50,000 particles, measurement times is set at 1, Kd value is set at the value obtained by using “standard particle 10.0 μm” (manufactured by Beckman•Coulter). A “threshold/noise level measuring button” is pressed to automatically set the threshold and the noise level. Furthermore, “current” is set at 1600 μA, “gain” is set at 2, and “electrolyte” is set at ISOTON II. “Flush aperture tube after measurement” is checked.

In the setting screen of “change pulse to particle diameter” of the special software, “bin interval” is set at logarithmic particle diameter, “particle-diameter bin” is set at 256 particle diameter bin, and “particle diameter range” is set at 2 μm to 60 μm.

Specific determination methods of a weight average particle diameter (D4) and a number average particle diameter (D1) are as follows.

(1) In a 250 mL round-bottom glass beaker for exclusive use of Multisizer 3, the aqueous electrolyte solution (about 200 mL) mentioned above is poured. The beaker is set on a sample stand. A stirrer rod is rotated counterclockwise at a rate of 24 rotations/second. Subsequently, stain and air bubbles within an aperture tube are removed by use of “flush of aperture” function of the special software.

(2) In a 100 mL flat-bottom glass beaker, the aqueous electrolyte solution (about 30 mL) is poured. To this, serving as a dispersant, about 0.3 mL of a diluted solution of “Contaminon N” (10 mass % aqueous solution of a neutral detergent consisting of a nonionic surfactant, an anionic surfactant, an organic builder, pH7, for cleaning a precision measuring apparatus, manufactured by Wako Pure Chemical Industries Ltd.) with ion exchanged water up to about 3 folds by mass is added.

(3) An ultrasonic disperser, “Ultrasonic Dispension System Tetora 150” (manufactured by Nikkaki Bios Co., Ltd) having an electric power of 120 W and having two oscillators with an oscillating frequency of 50 kHz (phases are shifted by 180°) is prepared. In a water vessel of the ultrasonic disperser, about 3.3 L of ion exchanged water is poured. To the water vessel, Contaminon N (about 2 mL) is added.

(4) The beaker prepared in (2) is set at a beaker standing hole of the ultrasonic disperser and then the ultrasonic disperser is actuated. Subsequently, the height of installation position of the beaker is controlled such that the resonance state of the liquid surface of the aqueous electrolyte solution in the beaker becomes a maximum.

(5) While applying ultrasonic wave to the aqueous electrolyte solution in the beaker set in (4), a toner (about 10 mg) is added in small portions to the aqueous electrolyte solution and dispersed. Subsequently, the ultrasonic dispersion treatment is continued for a further 60 seconds. Note that, in dispersion with ultrasonic wave, the temperature of water in the water vessel is appropriately controlled so as to fall within the range of 10° C. or more and 40° C. or less.

(6) To the round-bottom beaker prepared in (1) placed on a sample stand, the aqueous electrolyte solution prepared in (5) having a toner dispersed therein is added dropwise by a pipette to control the measurement concentration to be about 5%. Measurement is continued until the number of particles measured reaches 50,000.

(7) Measurement data is analyzed by the accompanying special software to calculate a weight average particle diameter (D4) and a number average particle diameter (D1). Note that, when graph/vol % is set in the special software, “average diameter” displayed in the screen of “analysis/volume statistical value (arithmetic average)” is the weight average particle diameter (D4). When graph/number % is set in the special software, “average diameter” displayed in the screen of an “analysis/number statistical value (arithmetic average)” is the number average particle diameter (D1).

<Method for Measuring of Average Circularity of Toner>

The average circularity of a toner is measured by a flow-system particle image analyzer “FPIA-3000” (manufactured by Sysmex Corporation) under the same measurement and analysis conditions as those for calibration work.

The measurement principle of the flow-system particle image analyzer “FPIA-3000” (manufactured by Sysmex Corporation) is that flowing particles are imaged as a static image and analyzed. The sample fed to a sample chamber is suctioned by a syringe and fed to a flat sheath flow cell. The sample fed to the flat sheath flow cell is sandwiched by the sheath liquid to form a flat flow. To the sample passing through the flat sheath flow cell, strobe light is applied at intervals of 1/60 seconds and thus flowing particles can be imaged as a static image. Furthermore, since the flow is flat, a focused image can be taken. A particle image is taken by a CCD camera and the image taken is processed at 512×512 image processing resolution (0.37 μm×0.37 μm per pixel). Outline extraction of each particle image is performed to measure e.g., the projected area S, peripheral length L of the particle image.

Next, the circle-equivalent diameter and circularity are obtained by using the area S and peripheral length L obtained above. The circle-equivalent diameter refers to the diameter of a circle having the same area as the projected area of a particle image. The circularity is defined as a value obtained by dividing the peripheral length of a circle obtained from a circle-equivalent diameter by the peripheral length of a particle projection image and calculated in accordance with the following expression.

Circularity=2×(π×S)^{1/2}/L

When a particle image is a circle, the circularity is 1. As the degree of irregularity of outer periphery of a particle image increases, the circularity decreases. After the circularity of each of the particles is calculated, the range of circularity from 0.200 to 1.000 is divided by 800 and the arithmetic average of the obtained values of circularity is calculated. The average value is defined as an average circularity.

The measurement method is specifically as follows. First, in a glass container, ion exchanged water (about 20 mL), from which e.g., solid impurities are previously removed, is poured. To the solution, serving as a dispersant, about 0.2 mL of a diluted solution of “Contaminon N” (10 mass % aqueous solution of a neutral detergent consisting of a nonionic surfactant, an anionic surfactant, an organic builder, pH 7, for cleaning a precision measuring apparatus, manufactured by Wako Pure Chemical Industries Ltd.) with ion exchanged water up to about 3 folds by mass is added. Furthermore, a measurement sample (about 0.02 g) is added. The mixture solution is dispersed by use of an ultrasonic disperser for 2 minutes to prepare a dispersion solution for measurement. At this time, the dispersion solution is appropriately cooled such that the temperature of the dispersion solution becomes 10° C. or more and 40° C. or less. As the ultrasonic disperser, a desktop type ultrasonic cleaner disperser having an oscillating frequency of 50 kHz and an electric power of 150 W (for example “VS-150” (manufactured by VELVO-CLEAR)) is used. A predetermined amount of ion exchanged water is poured in a water vessel. To the water vessel, Contaminon N (about 2 mL) is added.

Measurement is performed by use of a flow-system particle image analyzer as mentioned above having a regular objective lens (10×) installed therein. As a sheath liquid, a particle sheath “PSE-900A” (manufactured by Sysmex Corporation) is used. The dispersion solution prepared in accordance with the aforementioned procedure is fed to the flow-system particle image analyzer. Toner particles (3000 particles) are measured in HPF measuring mode (total count mode). In analyzing particles, the binarization threshold is set at 85% and the particles to be analyzed is limited to those having a circle-equivalent diameter of 1.985 μm or more and less than 39.69 μm and the average circularity of toner particles is obtained.

In measurement, before initiation of measurement, automatic focus control is performed by use of the standard latex particle (for example, “RESEARCH AND TEST PARTICLES Latex Microsphere Suspensions 5200A” (manufactured by Duke Scientific, diluted with ion exchanged water). Thereafter, it is favorable that focus is controlled every 2 hours from initiation of measurement.

Note that, in Examples, a flow-system particle image analyzer is used, which accompanies a calibration certificate issued by Sysmex Corporation. The certificate certifies that a calibration operation is performed by Sysmex Corporation. Measurement is performed under the same measurement and analysis conditions as in calibration work (based on which calibration certificate is issued) except that the analysis particle diameter is limited to a circle-equivalent diameter of 1.985 μm or more and less than 39.69 μm.

### EXAMPLES

Next, the present invention will be more specifically described below by way of Production Examples and Examples, which will not be construed as limiting the present invention.

Preparation of Magnetic Substance 1

While nitrogen gas is supplied at a rate of 20 L/minute to a reaction vessel equipped with a gas injection pipe, an aqueous ferrous sulfate solution (26.7 L) containing Fe²⁺ (1.5 mole/L) and an aqueous sodium silicate (No. 3) solution (1.0 L) containing Si⁴⁺ (0.2 mole/L) are added to a 3.4 mole/L aqueous sodium hydroxide solution (22.3 L), and pH is controlled to be 6.8 and the temperature is increased to 90° C. Furthermore, a 3.5 mole/L aqueous sodium hydroxide solution (1.2 L) is added and pH is controlled to be 8.5. Stirring is continued and air is supplied in place of the gas at a rate of 100 L/minute for 90 minutes. The mixture solution is neutralized to pH 7 with diluted sulfuric acid. The generated particles are washed with water, filtered, dried and pulverized to obtain magnetite, i.e., magnetic substance 1.

Magnetic substance 1 (spherical-shape magnetite, number average particle diameter: 0.25 μm, magnetization intensity: 63 Am²/kg, resistivity: 3.3×10⁵ Ω·cm) and a silane coupling agent (3-glycidoxypropylmethyldimethoxysilane) (1.2 parts by mass relative to 100 parts by mass of magnetite fine particles) are fed to a container. Subsequently, the resultant is mixed and stirred in the container at 100° C. for one hour at a high speed to treat the surface of magnetic substance 1.

Preparation of Magnetic Substances 2 to 11, 13 and 15 to 19

Magnetic substances different in shape and particle diameter distribution are obtained by changing the reaction temperature, pH of the reaction field, reaction time and addition of a silicate used for magnetic substance 1. The surface of magnetic substances 2 to 11, 13 and 15 to 19 is treated in the same manner as in magnetic substance 1 except that the conditions are changed to the conditions shown in Table 1.

Preparation of Magnetic Substances 12 and 14

Fe₂O₃ is mixed and stirred in a wet-process ball mill for 10 hours and pulverized. Polyvinyl alcohol (1 part by mass) is added, granulated, dried by a spray dryer and baked in an electric furnace under a nitrogen atmosphere of an oxygen concentration of 0.0 vol % at 900° C. for 10 hours.

The obtained magnetic substance is pulverized in a dry-process ball mill for 5 hours. Fine particles and rough particles are simultaneously classified and removed by a wind classifier (Elbow-jet, LABO EJ-L3, manufactured by Nittetsu Mining Co., Ltd.) to obtain (irregular-shape) magnetic substance 12 having vertexes. The surface treatment shown in Table 2 is performed in the same manner as in magnetic substance 1.

Magnetic substance 14 is obtained in the same manner as in magnetic substance 12 except that the pulverizing/classification conditions of magnetic substance 12 are changed, and then a surface treatment is performed in the same manner as in magnetic substance 1.

TABLE 1

| | | | | Number | | | | |
|---|---|---|---|---|---|---|---|---|
| | | | | average | | Magneti- | Lipophilic treatment | |
| | | | | particle | | zation | | Amount |
| | | | | diameter | Resistivity | intensity | | (parts by |
| | Type | Process | Shape | (μm) | (Ω · cm) | (Am²/kg) | Type | mass) |
| Magnetic | Magnetite | Synthesis | Spherical | 0.25 | 3.3 × 10⁵ | 63 | 3-glycidoxypropylmethyldimethoxysilane | 1.2 |
| substance 1 | | | shape | | | | | |
| Magnetic | Magnetite | Synthesis | Spherical | 0.20 | 3.0 × 10⁵ | 61 | 3-glycidoxypropylmethyldimethoxysilane | 1.5 |
| substance 2 | | | shape | | | | | |
| Magnetic | Magnetite | Synthesis | Spherical | 0.35 | 2.3 × 10⁵ | 63 | 3-glycidoxypropylmethyldimethoxysilane | 1.0 |
| substance 3 | | | shape | | | | | |
| Magnetic | Magnetite | Synthesis | Spherical | 0.15 | 2.0 × 10⁵ | 60 | 3-glycidoxypropylmethyldimethoxysilane | 2.1 |
| substance 4 | | | shape | | | | | |
| Magnetic | Magnetite | Synthesis | Spherical | 0.40 | 3.4 × 10⁵ | 64 | 3-glycidoxypropylmethyldimethoxysilane | 1.0 |
| substance 5 | | | shape | | | | | |
| Magnetic | Magnetite | Synthesis | Spherical | 0.15 | 2.5 × 10⁵ | 60 | 3-glycidoxypropylmethyldimethoxysilane | 2.1 |
| substance 6 | | | shape | | | | | |
| Magnetic | Magnetite | Synthesis | Spherical | 0.28 | 2.9 × 10⁵ | 63 | 3-glycidoxypropyltrimethoxysilane | 1.2 |
| substance 7 | | | shape | | | | | |
| Magnetic | Magnetite | Synthesis | Irregular | 0.60 | 4.1 × 10⁵ | 68 | 3-glycidoxypropyltrimethoxysilane | 0.4 |
| substance 8 | | | shape | | | | | |
| Magnetic | Magnetite | Synthesis | Irregular | 0.60 | 4.1 × 10⁵ | 68 | 3-glycidoxypropylmethyldimethoxysilane | 0.4 |
| substance 9 | | | shape | | | | | |
| Magnetic | Magnetite | Synthesis | Irregular | 0.85 | 3.8 × 10⁵ | 70 | 3-glycidoxypropyltrimethoxysilane | 0.3 |
| substance 10 | | | shape | | | | | |
| Magnetic | Magnetite | Synthesis | Irregular | 0.50 | 3.3 × 10⁵ | 66 | 3-glycidoxypropyltrimethoxysilane | 0.4 |
| substance 11 | | | shape | | | | | |
| Magnetic | Magnetite | Pulverizing | Irregular | 1.05 | 4.3 × 10⁵ | 70 | 3-glycidoxypropyltrimethoxysilane | 0.2 |
| substance 12 | | | shape | | | | | |
| Magnetic | Magnetite | Synthesis | Irregular | 0.60 | 4.1 × 10⁵ | 68 | 3-glycidoxypropylmethyldimethoxysilane | 0.5 |
| substance 13 | | | shape | | | | | |
| Magnetic | Magnetite | Pulverizing | Irregular | 1.70 | 4.6 × 10⁵ | 70 | 3-glycidoxypropyltrimethoxysilane | 0.2 |
| substance 14 | | | shape | | | | | |
| Magnetic | Magnetite | Synthesis | Irregular | 0.50 | 3.3 × 10⁵ | 66 | 3-glycidoxypropyltrimethoxysilane | 0.4 |
| substance 15 | | | shape | | | | | |
| Magnetic | Magnetite | Synthesis | Irregular | 0.40 | 4.0 × 10⁵ | 65 | 3-glycidoxypropyltrimethoxysilane | 0.4 |
| substance 16 | | | shape | | | | | |
| Magnetic | Magnetite | Synthesis | Octahedral | 0.75 | 4.3 × 10⁵ | 69 | 3-glycidoxypropyltrimethoxysilane | 0.4 |
| substance 17 | | | shape | | | | | |
| Magnetic | Magnetite | Synthesis | Irregular | 0.35 | 2.9 × 10⁵ | 64 | 3-glycidoxypropyltrimethoxysilane | 0.4 |
| substance 18 | | | shape | | | | | |
| Magnetic | Magnetite | Synthesis | Spherical | 0.70 | 4.7 × 10⁵ | 69 | 3-glycidoxypropyltrimethoxysilane | 0.4 |
| substance 19 | | | shape | | | | | |

As a result of observation of sections of magnetic-substance particles by a SEM, it was confirmed that magnetic substances 1 to 7 are magnetic substances having no vertexes; whereas, magnetic substances 8 to 19 are magnetic substances having vertexes. Note that, magnetic substances 8 to 16, 18 and 19 had vertexes of an acute angle.

Preparation of Carrier Core

Phenol 10.0 parts by mass

Formaldehyde solution (37% by mass aqueous formaldehyde solution) 15.0 parts by mass

Surface treated magnetic substance 1 70.0 parts by mass

Surface treated magnetic substance 8 30.0 parts by mass

25% by mass ammonia water 3.5 parts by mass

Water 15.0 parts by mass

The materials mentioned above are placed in a reaction batch and mixed well at a temperature of 40° C. Thereafter, the mixture is heated to a temperature of 85° C. at an average temperature increase rate of 1.5° C./minute while stirring, held at a temperature of 85° C. and subjected to a polymerization reaction for 3 hours to harden the mixture. The circumferential speed of a stirring vane at this time is set at 1.96 m/second.

After the polymerization reaction, the resultant is cooled to a temperature of 30° C. and water is added. The supernatant solution is removed and the obtained precipitate is washed with water and dried in the air. The obtained air-dried product is dried under reduced pressure (5 hPa or less) at a temperature of 60° C. to obtain carrier core 1 having a magnetic substance dispersed therein and having an average particle diameter of 36.4 μm.

The true specific gravity of carrier core 1 is 3.55 g/cm³, the resistivity at 1000 V/cm is 5.5×10⁷ Ω·cm, and the magnetization intensity at 79.6 kA/m is 58 Am²/kg.

Carrier core 1 is sectioned by FIB to prepare a section. The content of the magnetic substance B having vertexes in the region from the carrier core surface to a depth of 1.0 μm is 82 area %. The content of a magnetic substance having a horizontal Feret diameter of 0.5 μm or more in the region from the carrier core surface to a depth of 1.0 μm is 75 area %, and the content of the magnetic substance B having vertexes within the carrier core is 2 area %.

Carrier cores 2 to 19 are obtained in the same manner as in carrier core 1 except that the conditions are changed to those shown in Table 2. The resultant physical properties are shown in Table 2. Furthermore, a projection image which is a visualized reflection electron image of a section of carrier core 1 is shown in FIG. 1, and the projection image of carrier core 19 (Comparative Example) is shown in FIG. 4.

TABLE 2

| | Magnetic | | Magnetic | | | | | | | |
|---|---|---|---|---|---|---|---|---|---|---|
| | substance A | | substance B | | Resin | | Aldehyde | | Basic catalyst | |
| | | Amount | | Amount | | Amount | | Amount | | Amount |
| | | (parts by | | (parts by | | (parts by | | (parts by | | (parts by |
| | Type | mass) | Type | mass) | Type | mass) | Type | mass) | Type | mass) |
| Core | Magnetic | 70.0 | Magnetic | 30.0 | Phenol | 10.0 | Formaldehyde | 15.0 | Ammonia | 3.5 |
| 1 | substance | | substance | | | | (37% aqueous | | (25% | |
| | 1 | | 8 | | | | solution) | | aqueous | |
| | | | | | | | | | solution) | |
| Core | Magnetic | 60.0 | Magnetic | 40.0 | Phenol | 10.0 | Formaldehyde | 15.0 | Ammonia | 3.5 |
| 2 | substance | | substance | | | | (37% aqueous | | (25% | |
| | 1 | | 8 | | | | solution) | | aqueous | |
| | | | | | | | | | solution) | |
| Core | Magnetic | 75.0 | Magnetic | 25.0 | Phenol | 10.0 | Formaldehyde | 15.0 | Ammonia | 3.5 |
| 3 | substance | | substance | | | | (37% aqueous | | (25% | |
| | 1 | | 9 | | | | solution) | | aqueous | |
| | | | | | | | | | solution) | |
| Core | Magnetic | 70.0 | Magnetic | 30.0 | Phenol | 10.0 | Formaldehyde | 15.0 | Ammonia | 3.5 |
| 4 | substance | | substance | | | | (37% aqueous | | (25% | |
| | 1 | | 10 | | | | solution) | | aqueous | |
| | | | | | | | | | solution) | |
| Core | Magnetic | 55.0 | Magnetic | 45.0 | Phenol | 10.0 | Formaldehyde | 15.0 | Ammonia | 3.5 |
| 5 | substance | | substance | | | | (37% aqueous | | (25% | |
| | 1 | | 11 | | | | solution) | | aqueous | |
| | | | | | | | | | solution) | |
| Core | Magnetic | 80.0 | Magnetic | 20.0 | Phenol | 13.0 | Formaldehyde | 19.5 | Ammonia | 4.5 |
| 6 | substance | | substance | | | | (37% aqueous | | (25% | |
| | 1 | | 12 | | | | solution) | | aqueous | |
| | | | | | | | | | solution) | |
| Core | Magnetic | 80.0 | Magnetic | 20.0 | Phenol | 12.0 | Formaldehyde | 18.0 | Ammonia | 4.2 |
| 7 | substance | | substance | | | | (37% aqueous | | (25% | |
| | 1 | | 13 | | | | solution) | | aqueous | |
| | | | | | | | | | solution) | |
| Core | Magnetic | 80.0 | Magnetic | 20.0 | Phenol | 12.0 | Formaldehyde | 18.0 | Ammonia | 4.2 |
| 8 | substance | | substance | | | | (37% aqueous | | (25% | |
| | 2 | | 13 | | | | solution) | | aqueous | |
| | | | | | | | | | solution) | |
| Core | Magnetic | 80.0 | Magnetic | 20.0 | Phenol | 12.0 | Formaldehyde | 18.0 | Ammonia | 4.2 |
| 9 | substance | | substance | | | | (37% aqueous | | (25% | |
| | 3 | | 13 | | | | solution) | | aqueous | |
| | | | | | | | | | solution) | |
| Core | Magnetic | 80.0 | Magnetic | 20.0 | Phenol | 10.0 | Formaldehyde | 15.0 | Ammonia | 3.5 |
| 10 | substance | | substance | | | | (37% aqueous | | (25% | |
| | 4 | | 13 | | | | solution) | | aqueous | |
| | | | | | | | | | solution) | |
| Core | Magnetic | 80.0 | Magnetic | 20.0 | Phenol | 10.0 | Formaldehyde | 15.0 | Ammonia | 3.5 |
| 11 | substance | | substance | | | | (37% aqueous | | (25% | |
| | 5 | | 13 | | | | solution) | | aqueous | |
| | | | | | | | | | solution) | |
| Core | Magnetic | 70.0 | Magnetic | 30.0 | Phenol | 13.0 | Formaldehyde | 19.5 | Ammonia | 4.5 |
| 12 | substance | | substance | | | | (37% aqueous | | (25% | |
| | 1 | | 14 | | | | solution) | | aqueous | |
| | | | | | | | | | solution) | |
| Core | Magnetic | 80.0 | Magnetic | 20.0 | Phenol | 10.0 | Formaldehyde | 15.0 | Ammonia | 3.5 |
| 13 | substance | | substance | | | | (37% aqueous | | (25% | |
| | 6 | | 15 | | | | solution) | | aqueous | |
| | | | | | | | | | solution) | |
| Core | Magnetic | 80.0 | Magnetic | 20.0 | Phenol | 10.0 | Formaldehyde | 15.0 | Ammonia | 3.5 |
| 14 | substance | | substance | | | | (37% aqueous | | (25% | |
| | 1 | | 16 | | | | solution) | | aqueous | |
| | | | | | | | | | solution) | |
| Core | Magnetic | 70.0 | Magnetic | 30.0 | Phenol | 10.0 | Formaldehyde | 15.0 | Ammonia | 3.5 |
| 15 | substance | | substance | | | | (37% aqueous | | (25% | |
| | 7 | | 17 | | | | solution) | | aqueous | |
| | | | | | | | | | solution) | |
| Core | Magnetic | 80.0 | Magnetic | 20.0 | Phenol | 10.0 | Formaldehyde | 15.0 | Ammonia | 3.5 |
| 16 | substance | | substance | | | | (37% aqueous | | (25% | |
| | 1 | | 13 | | | | solution) | | aqueous | |
| | | | | | | | | | solution) | |
| Core | Magnetic | 80.0 | Magnetic | 20.0 | Phenol | 10.0 | Formaldehyde | 15.0 | Ammonia | 3.5 |
| 17 | substance | | substance | | | | (37% aqueous | | (25% | |
| | 1 | | 18 | | | | solution) | | aqueous | |
| | | | | | | | | | solution) | |
| Core | Magnetic | 80.0 | Magnetic | 20.0 | Phenol | 10.0 | Formaldehyde | 15.0 | Ammonia | 3.5 |
| 18 | substance | | substance | | | | (37% aqueous | | (25% | |
| | 1 | | 19 | | | | solution) | | aqueous | |
| | | | | | | | | | solution) | |
| Core | Magnetic | 100.0 | — | — | Phenol | 10.0 | Formaldehyde | 15.0 | Ammonia | 3.5 |
| 19 | substance | | | | | | (37% aqueous | | (25% | |
| | 1 | | | | | | solution) | | aqueous | |
| | | | | | | | | | solution) | |

| | | | | | | Content | Content | Content | Content |
|---|---|---|---|---|---|---|---|---|---|
| | | | | | | (area %) of | (area %) of | (area %) of | (area %) of |
| | Water | 50% | True | | Magneti- | magnetic | binder | magnetic | magnetic |
| | Amount | particle | specific | | zation | substance | resin on | substance | substance of |
| | (parts by | diameter | gravity | Resistivity | intensity | B on core | core | B within | 0.5 μm or more |
| | mass) | (μm) | (g/cm³) | (Ω · cm) | (Am²/kg) | surface | surface | core | on core surface |
| Core | 15.0 | 36.4 | 3.55 | 5.5 × 10⁷ | 58 | 82 | 62 | 2 | 75 |
| 1 | | | | | | | | | |
| Core | 15.0 | 35.8 | 3.59 | 1.3 × 10⁸ | 59 | 89 | 65 | 2 | 79 |
| 2 | | | | | | | | | |
| Core | 15.0 | 35.6 | 3.54 | 3.4 × 10⁷ | 57 | 77 | 53 | 10 | 71 |
| 3 | | | | | | | | | |
| Core | 15.0 | 36.0 | 3.55 | 5.0 × 10⁷ | 58 | 94 | 65 | 3 | 75 |
| 4 | | | | | | | | | |
| Core | 15.0 | 35.7 | 3.60 | 1.9 × 10⁷ | 60 | 91 | 43 | 3 | 51 |
| 5 | | | | | | | | | |
| Core | 15.0 | 37.2 | 3.51 | 8.0 × 10⁷ | 58 | 74 | 59 | 12 | 69 |
| 6 | | | | | | | | | |
| Core | 15.0 | 36.4 | 3.55 | 1.1 × 10⁷ | 58 | 67 | 50 | 25 | 64 |
| 7 | | | | | | | | | |
| Core | 15.0 | 38.2 | 3.57 | 5.2 × 10⁷ | 57 | 69 | 48 | 13 | 60 |
| 8 | | | | | | | | | |
| Core | 15.0 | 36.9 | 3.56 | 5.4 × 10⁷ | 60 | 73 | 53 | 5 | 65 |
| 9 | | | | | | | | | |
| Core | 15.0 | 37.7 | 3.54 | 2.5 × 10⁷ | 57 | 66 | 45 | 11 | 60 |
| 10 | | | | | | | | | |
| Core | 15.0 | 36.2 | 3.53 | 5.2 × 10⁷ | 58 | 70 | 53 | 10 | 66 |
| 11 | | | | | | | | | |
| Core | 20.0 | 45.1 | 3.50 | 9.0 × 10⁷ | 60 | 82 | 69 | 6 | 80 |
| 12 | | | | | | | | | |
| Core | 18.0 | 32.8 | 3.54 | 9.2 × 10⁶ | 56 | 62 | 36 | 13 | 45 |
| 13 | | | | | | | | | |
| Core | 18.0 | 31.5 | 3.51 | 9.8 × 10⁶ | 56 | 64 | 39 | 12 | 25 |
| 14 | | | | | | | | | |
| Core | 15.0 | 45.1 | 3.48 | 5.0 × 10⁷ | 57 | 38 | 29 | 46 | 35 |
| 15 | | | | | | | | | |
| Core | 15.0 | 35.6 | 3.54 | 9.0 × 10⁶ | 57 | 34 | 26 | 55 | 29 |
| 16 | | | | | | | | | |
| Core | 15.0 | 36.0 | 3.52 | 7.5 × 10⁷ | 56 | 78 | 24 | 12 | 12 |
| 17 | | | | | | | | | |
| Core | 15.0 | 36.8 | 3.56 | 4.5 × 10⁸ | 58 | — | 54 | — | 75 |
| 18 | | | | | | | | | |
| Core | 15.0 | 36.4 | 3.54 | 2.1 × 10⁸ | 56 | — | 23 | — | 0 |
| 19 | | | | | | | | | |

Preparation of Coating Resin Solution

A methyl methacrylate macromer (an average value n=50) having an ethylenic unsaturated group at one of the ends and having a weight average molecular weight of 5,000 (28 parts by mass), a cyclohexyl methacrylate monomer (70 parts by mass) having cyclohexyl as a unit and having an ester site and a methyl methacrylate monomer (2 parts by mass) are fed to a four-neck flask equipped with a reflux condenser, a thermometer, a nitrogen injection pipe and a rubbing stirrer. Furthermore, toluene (90 parts by mass), methyl ethyl ketone (110 parts by mass) and azobisisovaleronitrile (2.0 parts by mass) are added. The obtained mixture is maintained at 70° C. for 10 hours under nitrogen flow to obtain a solution of resin 1 (solid substance: 33% by mass). This solution was analyzed by gel permeation chromatography (GPC) to obtain a weight average molecular weight of 55,000. Furthermore, Tg is 94° C.

To a solution (30 parts by mass) of resin 1 obtained above, crosslinked polymethyl methacrylate particles (a maximum-peak particle diameter on a number distribution basis: 0.1 μm) (0.5 parts by mass), carbon black fine particle 1 (a maximum-peak particle diameter on a number distribution basis: 0.04 μm, resistivity: 9.0×10⁻¹ Ω·cm) (0.5 parts by mass) and toluene (70 parts by mass) are added. Subsequently, the mixture is more sufficiently stirred by a homogenizer to obtain resin solution 1 (coating-resin solid substance: 10% by mass).

A cyclohexyl methacrylate monomer (70 parts by mass) having a cyclohexyl as a unit and having an ester site and a methyl methacrylate monomer (30 parts by mass) are subjected to synthesis in the same manner as in resin 1 to obtain a solution of resin 2 (solid substance: 33% by mass). The weight average molecular weight is 57,800. Furthermore, Tg is 93° C. Resin solution 2 (coating-resin solid substance: 10% by mass) is obtained in the same manner as in resin solution 1 in accordance with the formulation shown in Table 3.

A methyl methacrylate monomer (100 parts by mass) is subjected to synthesis in the same manner as in resin 1 to obtain a solution of resin 2 (solid substance: 33% by mass). The weight average molecular weight is 60,000. Furthermore, Tg is 103° C. Resin solution 3 (coating-resin solid substance: 10% by mass) is obtained in the same manner as in resin solution 1 in accordance with the formulation shown in Table 3.

Resin solutions 4, 5 and 6 (coating-resin solid substance: 10% by mass) having a coating-resin solid substance of 10% by mass are obtained in the same manner as in resin solution 1 by adding particles, carbon black and toluene in accordance with the formulations shown in Table 3.

A silicone varnish (silicone resin solution: KR251, solid substance 20% by mass, manufactured by Shin-Etsu Chemical Co., Ltd.) (50 parts by mass) serving as resin 4 is mixed with toluene (50 parts by mass) to obtain resin solution 7 (coating-resin solid substance: 10% by mass).

In Table 3, carbon black fine particle 2 has a maximum-peak particle diameter on a number distribution basis of 0.03 μm and a resistivity of 4.0×10⁻² Ω·cm. Melamine is a crosslinked particle and has a maximum-peak particle diameter on a number distribution basis of 0.2 μm.

Production of Magnetic Carrier 1

Carrier core 1 (100 parts by mass) is fed to a nauta mixer (VN type manufactured by Hosokawa Micron Group) and stirred while rotating by setting the revolution of a screw type stirring vane at 3.5 rotations per minute and auto-rotation at 100 rotations per minute, and supplying nitrogen at a flow rate of 0.1 m³/min to reduce pressure (about 0.01 MPa). Furthermore, the mixture is heated to a temperature of 70° C. Coating resin solution 1 (total amount: 12 parts by mass) is added dropwise. The addition amount is divided into three portions (4 parts by mass for each), which are added at intervals of 20 minutes. After the entire amount is added dropwise, the mixture is continuously stirred for 30 minutes in order to remove the solvent. After cooling, a magnetic carrier is taken out. The coating amount relative to the carrier core (100 parts by mass) is 1.2 parts by mass. The magnetic carrier is transferred to a mixer having a rotatable mixing container equipped with a spiral vane (drum mixer UD-AT type, manufactured by Sugiyama Heavy Industrial) and treated with heat at a temperature of 100° C. for 2 hours under a nitrogen atmosphere. After cooling, the mixture is passed through a sieve having a mesh size of 75 μm to produce magnetic carrier 1. The physical properties of the obtained magnetic carrier are shown in Table 3.

Production of Magnetic Carriers 2 to 16 and 18 to 21

By appropriately changing the coating resin solution shown in Table 3, magnetic carriers 2 to 16 and 18 to 21 are produced in the same manner as in magnetic carrier 1. The physical properties of the resultant magnetic carriers are shown in Table 3.

Production of Magnetic Carrier 17

Magnetic carrier 17 is obtained by replacing coating resin solution 1 with coating resin solution 4 (10 parts by mass in total amount) and performing a coating treatment in the same manner as in magnetic carrier 1. The coating amount relative to the carrier core (100 parts by mass) is 1.0 part by mass. The magnetic carrier is transferred to a mixer having a rotatable mixing container equipped with a spiral vane (drum mixer UD-AT type, manufactured by Sugiyama Heavy Industrial) and treated with heat at a temperature of 160° C. for 2 hours under a nitrogen atmosphere. After cooling, the mixture is passed through a sieve having a mesh size of 75 μm to produce magnetic carrier 17. The physical properties of the obtained magnetic carrier are shown in Table 3.

TABLE 3

| | | Coating layer | | | | | | | | | Number of |
|---|---|---|---|---|---|---|---|---|---|---|---|
| | | | | Conduc- | Charge | | | | | | convex |
| | Core | | | tive | controlling | | | | | | portions of |
| | Type/ | | Resin/ | agent/ | particle/ | 50% | True | | | Magneti- | magnetic |
| | amount | | Amount | amount | amount | particle | specific | | | zation | substance |
| | (parts | Resin | (parts | (parts | (parts | diameter | gravity | Resistivity | | intensity | (portions/ |
| | by mass) | solution | by mass) | by mass) | by mass) | (μm) | (g/cm³) | (Ω · cm) | Rc/Rk | (Am²/kg) | μm²) |
| Magnetic | Core | Resin | Resin | Carbon | PMMA/0.06 | 36.8 | 3.53 | 3.0 × 10⁹ | 54.5 | 57 | 1.9 |
| carrier 1 | 1/100 | solution 1 | 1/1.2 | black 1/0.06 | | | | | | | |
| Magnetic | Core | Resin | Resin | Carbon | PMMA/0.06 | 38.1 | 3.49 | 4.2 × 10⁹ | 76.4 | 57 | 1.9 |
| carrier 2 | 1/100 | solution 2 | 2/1.2 | black 1/0.06 | | | | | | | |
| Magnetic | Core | Resin | Resin | Carbon | PMMA/0.06 | 38.6 | 3.48 | 6.8 × 10⁹ | 123.6 | 56 | 1.7 |
| carrier 3 | 1/100 | solution 3 | 3/1.2 | black 1/0.06 | | | | | | | |
| Magnetic | Core | Resin | Resin | — | — | 35.8 | 3.58 | 1.0 × 10⁸ | 0.8 | 59 | 2.8 |
| carrier 4 | 2/100 | solution 4 | 1/0.3 | | | | | | | | |
| Magnetic | Core | Resin | Resin | Carbon | PMMA/0.05 | 36.2 | 3.51 | 8.6 × 10⁸ | 25.3 | 56 | 2.2 |
| carrier 5 | 3/100 | solution 1 | 1/1.0 | black 1/0.05 | | | | | | | |
| Magnetic | Core | Resin | Resin | Carbon | PMMA/0.05 | 36.3 | 3.52 | 2.0 × 10⁹ | 40.0 | 58 | 2.3 |
| carrier 6 | 4/100 | solution 1 | 1/1.0 | black 1/0.05 | | | | | | | |
| Magnetic | Core | Resin | Resin | Carbon | — | 36.5 | 3.52 | 9.6 × 10⁷ | 5.1 | 58 | 2.5 |
| carrier 7 | 5/100 | solution 5 | 1/1.5 | black 1/0.15 | | | | | | | |
| Magnetic | Core | Resin | Resin | Carbon | PMMA/0.05 | 37.6 | 3.50 | 5.0 × 10⁸ | 6.3 | 57 | 2.3 |
| carrier 8 | 6/100 | solution 1 | 1/1.0 | black 1/0.05 | | | | | | | |
| Magnetic | Core | Resin | Resin | Carbon | PMMA/0.05 | 36.7 | 3.52 | 9.6 × 10⁷ | 8.7 | 57 | 2.3 |
| carrier 9 | 7/100 | solution 1 | 1/1.0 | black 1/0.05 | | | | | | | |
| Magnetic | Core | Resin | Resin | Carbon | PMMA/0.05 | 38.8 | 3.55 | 1.8 × 10⁸ | 3.5 | 56 | 2.3 |
| carrier 10 | 8/100 | solution 1 | 1/1.0 | black 1/0.05 | | | | | | | |
| Magnetic | Core | Resin | Resin | Carbon | PMMA/0.05 | 37.1 | 3.53 | 3.3 × 10⁹ | 61.1 | 59 | 2.0 |
| carrier 11 | 9/100 | solution 1 | 1/1.0 | black 1/0.05 | | | | | | | |
| Magnetic | Core | Resin | Resin | Carbon | PMMA/0.05 | 38.6 | 3.50 | 1.1 × 10⁸ | 4.4 | 56 | 1.9 |
| carrier 12 | 10/100 | solution 1 | 1/1.0 | black 1/0.05 | | | | | | | |
| Magnetic | Core | Resin | Resin | Carbon | PMMA/0.05 | 36.9 | 3.51 | 6.9 × 10⁹ | 132.7 | 56 | 1.6 |
| carrier 13 | 11/100 | solution 1 | 1/1.0 | black 1/0.05 | | | | | | | |
| Magnetic | Core | Resin | Resin | Carbon | Melamine/ | 45.2 | 3.48 | 1.2 × 10⁸ | 1.3 | 59 | 1.3 |
| carrier 14 | 12/100 | solution 6 | 1/2.0 | black 2/0.15 | 0.05 | | | | | | |
| Magnetic | Core | Resin | Resin | Carbon | PMMA/0.06 | 33.1 | 3.50 | 1.5 × 10⁹ | 163.0 | 54 | 1.1 |
| carrier 15 | 13/100 | solution 1 | 1/1.2 | black 1/0.06 | | | | | | | |
| Magnetic | Core | Resin | Resin | Carbon | PMMA/0.06 | 32.0 | 3.48 | 5.2 × 10⁹ | 530.6 | 55 | 0.8 |
| carrier 16 | 14/100 | solution 1 | 1/1.2 | black 1/0.06 | | | | | | | |
| Magnetic | Core | Resin | Resin | — | — | 46.5 | 3.45 | 2.0 × 10¹⁰ | 400.0 | 56 | 0.7 |
| carrier 17 | 15/100 | solution 7 | 4/1.0 | | | | | | | | |
| Magnetic | Core | Resin | Resin | Carbon | PMMA/0.06 | 35.1 | 3.52 | 6.3 × 10⁹ | 700.0 | 56 | 0.7 |
| carrier 18 | 16/100 | solution 1 | 1/1.2 | black 1/0.06 | | | | | | | |
| Magnetic | Core | Resin | Resin | Carbon | PMMA/0.06 | 36.6 | 3.49 | 1.1 × 10¹⁰ | 146.7 | 55 | 1.3 |
| carrier 19 | 17/100 | solution 1 | 1/1.2 | black 1/0.06 | | | | | | | |
| Magnetic | Core | Resin | Resin | Carbon | PMMA/0.06 | 37.0 | 3.55 | 9.8 × 10⁸ | 2.2 | 57 | 1.4 |
| carrier 20 | 18/100 | solution 1 | 1/1.2 | black 1/0.06 | | | | | | | |
| Magnetic | Core | Resin | Resin | Carbon | PMMA/0.06 | 36.9 | 3.51 | 1.2 × 10¹¹ | 571.4 | 55 | 1.6 |
| carrier 21 | 19/100 | solution 1 | 1/1.2 | black 1/0.06 | | | | | | | |

### Production Example of Polyester Resin 1

Terephthalic acid: 299 parts by mass
Trimellitic anhydride: 19 parts by mass
Polyoxypropylene (2.2)-2,2-bis(4-hydroxyphenyl)propane: 747 parts by mass
Titanium dihydroxybis(triethanolaminate): 1 part by mass

The materials mentioned above are weighed and placed in a reaction vessel equipped with a condenser pipe, a stirrer and a nitrogen inlet pipe. Thereafter, the mixture is heated to a temperature of 200° C. and nitrogen is fed to the reaction vessel. A reaction is carried out for 10 hours while removing generating water. Thereafter, the pressure is reduced to 1.3 kPa and a reaction is performed for one hour to obtain polyester resin 1 having a weight average molecular weight (Mw) of 6,100.

### Production Example of Polyester Resin 2

Terephthalic acid: 332 parts by mass
Polyoxyethylene (2.2)-2,2-bis(4-hydroxyphenyl)propane: 996 parts by mass
Titanium dihydroxybis(triethanolaminate): 1 part by mass

The materials mentioned above are weighed and placed in a reaction vessel equipped with a condenser pipe, a stirrer and a nitrogen inlet pipe. Thereafter, the mixture is heated to a temperature of 220° C. and nitrogen is fed to the reaction vessel. A reaction is carried out for hours while removing generating water. Furthermore, trimellitic anhydride (96 parts by mass) is added. The mixture is heated to a temperature of 180° C. and a reaction is performed for 2 hours to obtain polyester resin 2 having a weight average molecular weight (Mw) of 83,000.

### Production Example of Toner 1

Polyester resin 1: 80 parts by mass

Polyester resin 2: 20 parts by mass

Paraffin wax (melting point: 75° C.): 7 parts by mass

Cyan pigment (C. I. Pigment Blue 15:3): 7 parts by mass

Aluminum 3,5-di-t-butylsalicylate compound: 1 part by mass

The materials mentioned above are mixed well by a Henschel mixer (FM-75 type, manufactured by Nippon Coke Engineering Co., Ltd.) and kneaded by a double-shaft kneader (PCM-30 type, manufactured by IKEGAI) set at a temperature of 130° C. The kneaded product obtained is cooled, roughly pulverized by a hummer mill into particles having a size of 1 mm or less to obtain a coarse produce. The obtained coarse product is finely pulverized by a collision air current crusher using a high-pressure gas.

Next, the obtained product finely pulverized is classified by a wind classifier (Elbow-jet, LABO EJ-L3, manufactured by Nittetsu Mining Co., Ltd.) using the Coanda effect to simultaneously remove fine powder and coarse powder and further the surface thereof is modified by a mechanical surface modification apparatus (Faculty F-300, manufactured by Hosokawa Micron Group). At this time, the rotation number of a dispersion rotor is set at 7500 rpm and the rotation number of a classification rotor is set at 9500 rpm. The loading amount is set at 250 g per one cycle and the surface modification time (=cycle time, which is time from completion of raw material supply to opening of discharge valve) is set at 30 sec to obtain toner particle 1.

Subsequently, to toner particle 1 (100 parts by mass) as mentioned above, 1.0 part by mass of rutile type titanium oxide (average particle diameter: 0.02 μm, treated with n-decyltrimethoxysilane), 2.0 parts by mass of silica A (prepared by a vapor phase oxidation method, average particle diameter: 0.04 μm, treated with silicone oil) and 2.0 parts by mass of silica B (prepared by a sol-gel method, average particle diameter: 0.11 μm, treated with HMDS) are added and mixed by a 5 Liter Henschel mixer at a circumferential speed of 30 m/s for 15 minutes. Thereafter, coarse particles are removed by a sieve having a mesh size of 45 μm to obtain toner 1.

Physical properties of toner 1 are shown in Table 4.

### Production Example of Toner 2

To ion exchanged water (500 parts by mass), a 0.12 mole/liter aqueous Na₃PO₄ solution (600 parts by mass) is poured. After the mixture is heated to a temperature of 60° C., the mixture is stirred by a TK system homomixer (manufactured by Tokushu Kika Kogyo) at a rate of 11,000 rpm. To the mixture, a 1.2 mole/liter aqueous CaCl₂ solution (93 parts by mass) is gradually added to obtain an aqueous medium containing Ca₃(PO₄)₂.
Styrene 162.0 parts by mass
N-butyl acrylate 38.0 parts by mass
Ester wax (behenyl behenate: melting point 78° C.) 20.0 parts by mass
Aluminum compound of di-tertiary butyl salicylate 1.0 part by mass
Saturated polyester (terephthalic acid-propyleneoxide modified bisphenol A, acid value: 15 mg KOH/g, peak molecular weight: 6000) 10.0 parts by mass
Cyan pigment (Pigment Blue 15:3) 13.0 parts by mass

The materials mentioned above are heated to a temperature of 60° C. and homogeneously dissolved and dispersed by use of a TK system homomixer (manufactured by Tokushu Kika Kogyo) at a rate of 10,000 rpm. In this, a polymerization initiator, 2,2′-azobis(2,4-dimethylvaleronitrile) (8 parts by mass) is dissolved to prepare a monomer composition.

To the aqueous medium mentioned above, the above monomer composition is added. The mixture is stirred at a temperature of 60° C. under a nitrogen atmosphere by a TK system homomixer at a rate of 10,000 rpm for 10 minutes to granulate the monomer composition. Thereafter, the granulated product is heated to a temperature of 80° C. while stirring by a paddle stirring vane and reacted for 10 hours. After completion of the polymerization reaction, the remaining monomer is distilled away under reduced pressure. After cooling, hydrochloric acid is added to dissolve Ca₃(PO₄)₂. The mixture is filtered, washed with water and dried to obtain toner particle 2.

Externally addition is performed in the same manner as in toner 1 to obtain toner 2.

The physical properties of toner 2 are shown in Table 4.

TABLE 4

| | Weight average | Average |
|---|---|---|
| | particle diameter (D4) | circularity |
| Toner 1 | 5.8 μm | 0.960 |
| Toner 2 | 6.3 μm | 0.982 |

### Example 1

To magnetic carrier 1 (92 parts by mass), toner 1 (8 parts by mass) is added. The mixture is stirred by a V-shape mixer (V-20, manufactured by Seishin Enterprise Co., Ltd.) to obtain a two-component developer as shown in Table 5.

Using a complex machine, modified image RUNNER ADVANCE C5045 manufactured by Cannon Inc. for digital offices as an image forming apparatus, the two-component developer is fed to a developing apparatus which is used for cyan and toner 1 is fed to a supplemental bottle which is used for cyan. An image is formed and evaluated as follows. Note that, the image forming apparatus is modified by applying rectangular AC voltage (a frequency of 8.0 kHz, Vpp of 0.7 kV) and DC voltage V_{DC} to a developer carrying member and by closing the discharge port for the developing agent of the development container. In evaluating an image after long-time repeated use, DC voltage V_{DC} of a developer carrying member, charge voltage V_{D} of an electrostatic latent image bearing member and a laser power are controlled to adjust toner consumption to the same level such that the amount of toner for an FFh image (solid image) to be mounted on a paper sheet is 0.50 mg/cm². FFh refers to 256 gradations represented by hexadecimal notation. 00h represents 1st gradation (a white portion) of the 256 gradations and FFh represents the 256th gradation (a solid portion) of the 256 gradations.

As an output test of an image after long-time repeated use, a solid-image (FFh output) bar chart having an image proportion of 40% is output on 50,000 A4 paper sheets.

Printing environment High temperature and high humidity environment: temperature 30° C./humidity 80% RH environment (hereinafter referred to as “H/H”)

Paper Paper sheet GF-0081 (81.4 g/m²) for a laser beam printer (manufactured by Cannon Marketing Japan Inc.)

Evaluation is performed based on the following evaluation method. The results are shown in Table 6.

Developing Performance

Developing performance of the initial printing is evaluated. A solid image (FFh) is formed an electrostatic latent image bearing member. Before the solid image is transferred to an intermediate transfer member, rotation of the electrostatic latent image bearing member is stopped and the toner on the electrostatic latent image bearing member is suctioned and collected by a metal cylindrical tube (Faraday cage) equipped with a cylindrical filter. At this time, the amount of charge Q charged in a condenser through the metal cylindrical tube is measured and image area S is determined from the amount of toner collected. Based on these, the amount of charge per unit area Q/S (mC/kg) is obtained, and then, the amount of charge per unit area Q/S (mC/kg) is divided by contrast potential (Vcont) to obtain Q/S/Vcont (μC·s³·A·m⁻⁴·kg⁻¹). Based on this value, developing performance is evaluated.

A: 1.20 or more

B: 1.10 or more and less than 1.20

C: 1.00 or more and less than 1.10

D: 0.90 or more and less than 1.00

E: less than 0.90

Image Defect (White Spot)

A chart in which half tone transverse bands (30h, width: 10 mm) and solid image transverse bands (FFh, width: 10 mm) are arranged alternately in the feed direction of a transfer paper sheet is output. The output images are read out by a scanner and then subjected to binarization processing. Note that the 30h of the image is a value representing a half-tone image when 256 gradations are expressed by hexadecimal numbers in which 00h represents solid white and FFh represents solid black. In a binarized image along the feed direction, the brightness distribution (256 gradations) in a certain line is obtained. At this time, a tangent line is drawn at a point showing the brightness expressing a half tone. Until the tangent line is crossed with a point showing the brightness expressing a solid image, the region (area: the sum of brightness values) of a brightness deviated from the tangent line of a half tone image portion rear edge is defined as the degree of a white spot.

(Evaluation Standard of White Spots)

A: 50 or less

B: 51 or more and 150 or less

C: 151 or more and 300 or less

D: 301 or more and 500 or less

E: 501 or more

Leakage (White Spot)

Leakage is evaluated. On five A4 plain paper sheets, a solid (FFh) image is continuously output. White spots of 1 mm or more in diameter are counted in the image formed on five sheets and the total number is calculated. Leakage is evaluated based on the following criteria. Image output in the leakage evaluation differs from normal image output in that rectangular AD voltage (a frequency of 8.0 kHz and Vpp of 1.2 kV) is applied to a developer carrying member.

A: 0 dots

B: 1 dot or more and less than 6 dots

C: 6 dots or more and less than 10 dots

D: 10 dots or more and less than 20 dots

E: 20 dots or more

Q/M Retention Rate

Q/M on an electrostatic latent image bearing member before and after long-time repeated use is evaluated. On the electrostatic latent image bearing member, a solid image (FFh) is formed. Before the solid image is transferred to an intermediate transfer member, rotation of the electrostatic latent image bearing member is stopped and the toner on the electrostatic latent image bearing member is suctioned and collected by a metal cylindrical tube (Faraday cage) equipped with a cylindrical filter. At this time, the amount of charge Q charged in a condenser through the metal cylindrical tube is measured and the mass M of the toner collected is measured. The amount of charge per unit mass Q/M (mC/kg) is calculated to obtain a value of Q/M (mC/kg) on the electrostatic latent image bearing member.

When the absolute value of Q/M on the initial electrostatic latent image bearing member is regarded as 100%, the absolute value of Q/M on the electrostatic latent image bearing member after long-time repeated use is calculated and then a retention rate of Q/M absolute value is obtained. Evaluated is made based on the following criteria.

Retention rate (%)=|Q/M after long-time repeated use|/|initial Q/M|×100

A: Q/M retention rate on electrostatic latent image bearing member is 90% or more

B: Q/M retention rate on electrostatic latent image bearing member is 80% or more and less than 90%

C: Q/M retention rate on electrostatic latent image bearing member is 70% or more and less than 80%

D: Q/M retention rate on electrostatic latent image bearing member is 60% or more and less than 70%

E: Q/M retention rate on electrostatic latent image bearing member is less than 60%

### Examples 2 to Examples 17, Comparative Examples 1 to 5

As shown in Table 5, a toner and a magnetic carrier are mixed in predetermined amounts and evaluation is performed in the same manner as in Example 1. Evaluation results are shown in Table 7.

In Comparative Example 1, the magnetic substance used is an octahedral shape. Since the particles having vertexes are not selectively present at the carrier core surface, the resistivity of the magnetic carrier increases. As a result, developing performance is poor and long-term stability is poor.

In Comparative Example 2, the content of the magnetic particles having vertexes on the carrier core surface is low and leakage significantly occurs.

In Comparative Example 3, since the number average particle diameter of the particles having vertexes used is small, the resistance of the carrier core surface cannot be increased. Thus, leakage significantly occurs.

In Comparative Example 4, since the magnetic substance used is a spherical shape, long-term stability is poor by toner spent, and leakage cannot be prevented.

In Comparative Example 5, since small and virtually spherical magnetic substance alone is used, the resistivity of the magnetic carrier is high. Thus, developing performance is poor and long-term stability is poor by toner spent.

TABLE 5

| | | | Toner Density |
|---|---|---|---|
| | Toner | Magnetic carrier | (mass %) |
| Example 1 | Toner 1 | Magnetic carrier 1 | 8 |
| Example 2 | Toner 1 | Magnetic carrier 2 | 8 |
| Example 3 | Toner 1 | Magnetic carrier 3 | 8 |
| Example 4 | Toner 1 | Magnetic carrier 4 | 8 |
| Example 5 | Toner 1 | Magnetic carrier 5 | 8 |
| Example 6 | Toner 1 | Magnetic carrier 6 | 8 |
| Example 7 | Toner 1 | Magnetic carrier 7 | 8 |
| Example 8 | Toner 1 | Magnetic carrier 8 | 8 |
| Example 9 | Toner 1 | Magnetic carrier 9 | 8 |
| Example 10 | Toner 1 | Magnetic carrier 10 | 8 |
| Example 11 | Toner 1 | Magnetic carrier 11 | 8 |
| Example 12 | Toner 1 | Magnetic carrier 12 | 8 |
| Example 13 | Toner 1 | Magnetic carrier 13 | 8 |
| Example 14 | Toner 1 | Magnetic carrier 14 | 6 |
| Example 15 | Toner 1 | Magnetic carrier 15 | 8 |
| Example 16 | Toner 1 | Magnetic carrier 16 | 8 |
| Comparative | Toner 1 | Magnetic carrier 17 | 8 |
| Example 1 | | | |
| Comparative | Toner 1 | Magnetic carrier 18 | 8 |
| Example 2 | | | |
| Comparative | Toner 1 | Magnetic carrier 19 | 8 |
| Example 3 | | | |
| Comparative | Toner 1 | Magnetic carrier 20 | 8 |
| Example 4 | | | |
| Comparative | Toner 1 | Magnetic carrier 21 | 8 |
| Example 5 | | | |
| Example 17 | Toner 2 | Magnetic carrier 1 | 8 |

TABLE 6

| | | | Developing | | Image defect | | Leakage | | | | |
|---|---|---|---|---|---|---|---|---|---|---|---|
| | | | performance | | (white spot) | | (white spot) | | Q/M Retention rate | | |
| | | | Initial | After | Initial | After | Initial | After | Initial | After 50000 | Retention |
| | | Magnetic | first | 50000 | first | 50000 | first | 50000 | first print | prints | rate |
| | Toner | carrier | print | prints | print | prints | print | prints | (-mC/kg) | (-mC/kg) | (%) |
| Example 1 | Toner | Magnetic | A | A | A | A | A | A | 35 | 33 | A |
| | 1 | carrier 1 | 1.25 | 1.26 | 30 | 29 | 0 | 0 | | | 94 |
| Example 2 | Toner | Magnetic | A | A | A | B | A | A | 36 | 32 | B |
| | 1 | carrier 2 | 1.23 | 1.22 | 41 | 106 | 0 | 0 | | | 89 |
| Example 3 | Toner | Magnetic | A | B | A | C | A | B | 38 | 32 | B |
| | 1 | carrier 3 | 1.20 | 1.16 | 45 | 152 | 0 | 1 | | | 84 |
| Example 4 | Toner | Magnetic | B | B | A | A | B | C | 33 | 30 | A |
| | 1 | carrier 4 | 1.18 | 1.16 | 46 | 47 | 3 | 9 | | | 91 |
| Example 5 | Toner | Magnetic | A | A | A | A | B | C | 37 | 34 | A |
| | 1 | carrier 5 | 1.22 | 1.20 | 43 | 49 | 2 | 9 | | | 92 |
| Example 6 | Toner | Magnetic | A | A | A | A | A | A | 36 | 33 | A |
| | 1 | carrier 6 | 1.24 | 1.22 | 32 | 38 | 0 | 0 | | | 92 |
| Example 7 | Toner | Magnetic | A | B | A | A | B | B | 37 | 34 | A |
| | 1 | carrier 7 | 1.20 | 1.19 | 47 | 49 | 3 | 5 | | | 92 |
| Example 8 | Toner | Magnetic | A | B | A | B | A | A | 37 | 33 | B |
| | 1 | carrier 8 | 1.23 | 1.19 | 40 | 52 | 0 | 0 | | | 89 |
| Example 9 | Toner | Magnetic | A | A | A | A | B | B | 36 | 33 | A |
| | 1 | carrier 9 | 1.24 | 1.24 | 31 | 33 | 1 | 3 | | | 92 |
| Example 10 | Toner | Magnetic | A | A | A | A | A | B | 36 | 33 | A |
| | 1 | carrier 10 | 1.22 | 1.20 | 35 | 41 | 0 | 4 | | | 92 |
| Example 11 | Toner | Magnetic | A | B | A | B | A | A | 37 | 33 | B |
| | 1 | carrier 11 | 1.21 | 1.15 | 46 | 101 | 0 | 0 | | | 89 |
| Example 12 | Toner | Magnetic | A | A | A | A | B | C | 35 | 32 | A |
| | 1 | carrier 12 | 1.23 | 1.22 | 36 | 39 | 4 | 7 | | | 91 |
| Example 13 | Toner | Magnetic | A | B | A | B | A | B | 35 | 32 | A |
| | 1 | carrier 13 | 1.20 | 1.13 | 48 | 104 | 0 | 4 | | | 91 |
| Example 14 | Toner | Magnetic | A | B | A | B | A | A | 37 | 32 | B |
| | 1 | carrier 14 | 1.22 | 1.18 | 45 | 56 | 0 | 0 | | | 86 |
| Example 15 | Toner | Magnetic | A | A | A | A | C | C | 35 | 31 | B |
| | 1 | carrier 15 | 1.21 | 1.22 | 39 | 37 | 6 | 8 | | | 89 |
| Example 16 | Toner | Magnetic | A | A | A | B | C | C | 34 | 29 | B |
| | 1 | carrier 16 | 1.22 | 1.20 | 46 | 59 | 8 | 9 | | | 85 |
| Comparative | Toner | Magnetic | C | D | C | D | A | C | 39 | 31 | C |
| Example 1 | 1 | carrier 17 | 1.08 | 0.98 | 287 | 342 | 0 | 7 | | | 79 |
| Comparative | Toner | Magnetic | B | C | C | C | D | D | 35 | 30 | B |
| Example 2 | 1 | carrier 18 | 1.17 | 1.09 | 156 | 202 | 14 | 17 | | | 86 |
| Comparative | Toner | Magnetic | B | B | B | B | C | D | 34 | 27 | C |
| Example 3 | 1 | carrier 19 | 1.18 | 1.12 | 57 | 100 | 7 | 13 | | | 79 |
| Comparative | Toner | Magnetic | B | D | B | D | D | E | 33 | 24 | C |
| Example 4 | 1 | carrier 20 | 1.19 | 0.99 | 51 | 303 | 10 | 21 | | | 72 |
| Comparative | Toner | Magnetic | C | D | D | D | A | A | 36 | 24 | D |
| Example 5 | 1 | carrier 21 | 1.06 | 0.93 | 320 | 452 | 0 | 0 | | | 67 |
| Example 17 | Toner | Magnetic | A | A | A | A | A | A | 38 | 35 | A |
| | 2 | carrier 1 | 1.30 | 1.27 | 27 | 38 | 0 | 0 | | | 92 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-175723, filed Aug. 8, 2012, which is hereby incorporated by reference herein in its entirety.

### REFERENCE SIGNS LIST

1 resin container
2 lower electrode
3 support base
4 upper electrode
5 sample
6 electrometer
7 control computer
A resistance measurement cell
d sample height

What is claimed is:

1. A magnetic carrier comprising:
a magnetic substance-dispersed resin carrier core, which contains a magnetic substance and a binder resin, and
a coating resin on a surface thereof,
wherein:
the magnetic substance comprises
a magnetic substance A having a shape without vertexes and
a magnetic substance B having a shape with vertexes,
the magnetic substance B has a number average particle diameter of 0.40 μm or more and 2.00 μm or less, and
in a reflection electron image of a section of the magnetic substance-dispersed resin carrier core taken by a scanning electron microscope,
an area proportion of the magnetic substance B is larger than an area proportion of the magnetic substance A within a region from the surface of the magnetic substance-dispersed resin carrier core to a depth of 1.0 μm.

2. The magnetic carrier according to claim 1, wherein within the region, a proportion of the magnetic substance having a horizontal Feret diameter of 0.50 μm or more is 70 area % or more based on an area proportion of all magnetic substances having a horizontal Feret diameter of 0.10 μm or more.

3. The magnetic carrier according to claim 1, wherein within the region, a proportion of a binder resin portion is 40% or more and 80% or less with respect to a sum of an area of the binder resin portion and a magnetic substance portion.

4. The magnetic carrier according to claim 1, wherein the magnetic substance A has a number average particle diameter of 0.15 μm or more and 0.40 μm or less.

5. The magnetic carrier according to claim 4, wherein the number average particle diameter of the magnetic substance A is 0.20 μm or more and 0.35 μm or less.

6. The magnetic carrier according to claim 1, wherein a content of the magnetic substance B is 10% by mass or more and 40% by mass or less with respect to a total amount of the magnetic substance A and the magnetic substance B.

7. The magnetic carrier according to claim 1, wherein the coating resin comprises a resin having a unit derived from a monomer having a cyclic hydrocarbon group as a repeating unit.

8. A two-component developer comprising a toner and the magnetic carrier according to claim 1.
